(19) United States
(12) Patent Application Publication
(10) Pub. No.: US 2013/0084495 A1
(43) Pub. Date: Apr. 4, 2013

(54) POWER STORAGE DEVICE

(71) Applicant: Semiconductor Energy Laboratory Co., Ltd., Atsugi-shi (JP)

(72) Inventors: Ryota TAJIMA, Isehara (JP); Kunio HOSOYA, Atsugi (JP); Takeshi OSADA, Isehara (JP); Teppei OGUNI, Atsugi (JP); Shunpei YAMAZAKI, Tokyo (JP)

(73) Assignee: SEMICONDUCTOR ENERGY LABORATORY CO., LTD., Atsugi-shi (JP)

(21) Appl. No.: 13/625,111

(22) Filed: Sep. 24, 2012

(30) Foreign Application Priority Data
Sep. 30, 2011 (JP) 2011-217069

(51) Int. Cl. H01M 4/38; H01M 4/583; H01M 4/02; H01M 4/64; B82Y 30/00

(52) U.S. Cl. 429/211; 429/209; 429/218.1; 429/231.8; 977/734; 977/948

(57) ABSTRACT

Provided is a power storage device in which charge/discharge capacity is high, charge/discharge can be performed at high speed, and deterioration in battery characteristics due to charge/discharge is small. The power storage device includes a negative electrode including an active material including a plurality of prism-like protrusions. A cross section of each of the plurality of prism-like protrusions, which is perpendicular to the axis of each protrusion, is a polygonal shape or a polygonal shape including a curve, such as a cross shape, an H shape, an L shape, an I shape, a T shape, a U shape, or a Z shape. The active material including the plurality of prism-like protrusions may be covered with graphene.

### BACKGROUND OF THE INVENTION

1. Field of the Invention

The present invention relates to a power storage device.

2. Description of the Related Art

In recent years, with the advance of environmental technology, development of power generation devices (e.g., solar power generation devices) which pose less burden on the environment than conventional power generation devices has been actively conducted. Concurrently with the development of power generation technology, development of power storage devices such as lithium-ion secondary batteries, lithium-ion capacitors, and air cells has also been underway.

In order to increase capacity of these power storage devices, provision of a plurality of prism-like protrusions for a positive electrode and a negative electrode has been proposed (see Patent Documents 1 to 3). In order to reduce pressure applied by the protrusions to a separator provided between the positive electrode and the negative electrode, an insulator is provided at a tip of each protrusion of the positive electrode and the negative electrode.

Further, as a lithium-battery electrode integrated over a silicon chip, silicon pillars which are formed over an n-type silicon wafer and each have a submicron diameter have been proposed (see Patent Document 4). Patent Document 4 discloses that the pillars are formed by island lithography or photolithography.

In general, an electrode for a power storage device includes a current collector, an active material provided on and in contact with the current collector, and the like. As a negative electrode active material, a material which can occlude and release ions functioning as carriers (hereinafter referred to as carrier ions), such as carbon or silicon, is used. For example, silicon or phosphorus-doped silicon can occlude about four times as many carrier ions as carbon and thus has higher theoretical capacity than carbon and is advantageous in increasing the capacity of the power storage device. Therefore, a further increase in capacity can be expected when such a negative electrode active material is used in combination with the prism-like protrusion structure.

However, when the amount of carrier ions occluded by a negative electrode active material is increased, volume change due to occlusion and release of carrier ions in charge/discharge cycles is increased, and thus adhesion between a current collector and silicon is decreased. As a result, a problem of deterioration of battery characteristics due to repeated charge and discharge arises.

Accordingly, a layer formed using silicon is formed over a current collector and a layer formed using graphite is formed over the layer formed using silicon, thereby reducing deterioration of battery characteristics due to expansion and contraction of the layer formed using silicon (see Patent Document 5). Silicon has lower electric conductivity than carbon; thus, by covering surfaces of silicon particles with graphite and forming an active material layer including the silicon particles over a current collector, a negative electrode in which the resistivity of the active material layer is reduced is manufactured.

In recent years, the use of graphene as a conductive electronic material in semiconductor devices has been studied.

Graphene is chemically stable, has favorable electric characteristics, and thus has been expected to be applied to channel regions of transistors, vias, wirings, and the like included in the semiconductor devices. In addition, particles of an active material are covering with graphite or graphene in order to increase the conductivity of a material for an electrode in a lithium-ion battery (see Patent Document 6).

### REFERENCE

### Patent Documents

[Patent Document 1] Japanese Published Patent Application No. 2010-219030

[Patent Document 2] Japanese Published Patent Application No. 2010-239122

[Patent Document 3] Japanese Published Patent Application No. 2010-219392

[Patent Document 4] Japanese Published Patent Application No. 2010-135332

[Patent Document 5] Japanese Published Patent Application No. 2001-283834

[Patent Document 6] Japanese Published Patent Application No. 2011-029184

### SUMMARY OF THE INVENTION

However, in the case where the prism-like protrusions are used for the electrode of a power storage device, it is difficult to maintain enough mechanical strength of the protrusions. In other words, because of its structure, the prism-like protrusions have poor resistance to impact and vibration. Further, because of occlusion and release of carrier ions by the protrusions due to repeated charge/discharge, shapes of the protrusions change, which leads to difficulty in maintaining strength. Furthermore, advance of a decrease in strength causes the protrusions to separate from a current collector. Moreover, since electrodes are rolled in a cylindrical power storage device, a rectangular power storage device, and the like, it is difficult to employ an electrode having a structure including protrusions with poor mechanical strength in such power storage devices.

When a layer formed using silicon provided over a current collector is covered with a layer formed using graphite, since the thickness of the layer formed using graphite is large, e.g., submicron to micron, the amount of carrier ions transferred between an electrolyte and the layer formed using silicon is reduced. In addition, in an active material layer including silicon particles covered with graphite, the amount of silicon contained in the active material layer is reduced. Consequently, the amount of reaction between silicon and carrier ions is reduced, which causes a reduction in charge/discharge capacity and makes it difficult to perform charge/discharge at high speed in a power storage device.

In addition, even when particles of an active material are covered with graphene, it is difficult to suppress expansion of the volume of the particles of the active material owing to repeated charge/discharge and to suppress pulverization of the particles of the active material due to the expansion.

In view of the above, an embodiment of the present invention provides a power storage device in which charge/discharge capacity is high, charge/discharge can be performed at high speed, and deterioration in battery characteristics due to charge/discharge is small.

An embodiment of the present invention is a power storage device including a negative electrode including an active material including a plurality of prism-like protrusions (or a plurality of protrusion). The shape of a cross section of each of the plurality of prism-like protrusions, which is perpendicular to an axis of each protrusion, is a polygonal shape (it may be called a “concave polygonal shape”, when it includes a corner with an inner angle greater than 180°), or a polygonal shape including a curve, such as a cross shape, an H shape, an L shape, an I shape, a T shape, a U shape, or a Z shape, so that the mechanical strength of the prism-like protrusions is increased as compared to that of a protrusion having a square cross section or a protrusion having a circular cross section.

An embodiment of the present invention is a power storage device including a negative electrode including a current collector and an active material including a plurality of prism-like protrusions over the current collector. The shape of a cross section of each of the plurality of prism-like protrusions, which is perpendicular to an axis of each protrusion, is a polygonal shape or a polygonal shape including a curve, such as a cross shape, an H shape, an L shape, an I shape, a T shape, a U shape, or a Z shape, so that the mechanical strength of the prism-like protrusions is increased as compared to that of a protrusion having a square cross section or a protrusion having a circular cross section.

Further, in the power storage device according to any of the above embodiments of the present invention, the plurality of prism-like protrusions and a top surface of the active material are covered with graphene.

Further, in the power storage device according to any of the above embodiments of the present invention, the plurality of prism-like protrusions is arranged in translation symmetry.

In addition to the plurality of prism-like protrusions, the active material included in the negative electrode may include a common portion to which the plurality of prism-like protrusions is connected. The common portion is a region with which the entire top surface of the current collector is covered and which is formed using a material similar to that of the plurality of prism-like protrusions. In the case where prism-like protrusions are formed in a layered active material in an etching step, portions which are not removed by the etching are the prism-like protrusions and the common portion.

Here, a prism-like protrusion can be defined as a protrusion having one axis. The axis of the protrusion is a straight line which passes both a top portion (or the center of a top surface) of the protrusion and the center of a plane where the protrusion is in contact with the common portion or the current collector. In other words, the axis of the protrusion is a straight line which passes the center of the longitudinal direction of the prism-like protrusion. Further, a state where the straight lines of the plurality of prism-like protrusions are substantially parallel to each other is referred to as “axes of a plurality of prism-like protrusions are oriented in the same direction”. Typically, an angle between the straight lines of the plurality of prism-like protrusions is less than or equal to 10 degrees, preferably less than or equal to 5 degrees. In other words, a prism-like protrusion means a structural body in which size and the like are processed as planned by a method for selectively removing part of an active material layer utilizing a semiconductor processing technique such as anisotropic or isotropic etching. As described above, the plurality of prism-like protrusions is structural bodies formed in an etching step and is different from whisker-like structural bodies which grow in random directions.

Note that the shape of the prism-like protrusion includes a pyramidal shape, a plate-like shape, and a hollow shape. Further, a protective layer may be provided between graphene and a tip of each of the plurality of protrusions.

The common portion and the plurality of prism-like protrusions may be formed using silicon. Alternatively, the common portion and the plurality of prism-like protrusions may be formed using silicon to which an impurity imparting conductivity, such as phosphorus or boron, is added. Further, the common portion and the plurality of prism-like protrusions may be formed using single crystal silicon, polycrystalline silicon, or amorphous silicon. Alternatively, the common portion may be formed using single crystal silicon or polycrystalline silicon and the plurality of prism-like protrusions may be formed using amorphous silicon. Further alternatively, the common portion and part of the plurality of prism-like protrusions may be formed using a single crystal structure or a polycrystalline structure and the other part of the plurality of prism-like protrusions may be formed using an amorphous structure.

Note that graphene in this specification includes single-layer graphene and multilayer graphene including two to hundred layers. Single-layer graphene refers to a sheet of one atomic layer of carbon molecules having π bonds. Graphene may contain oxygen at higher than or equal to 2 at. % and lower than or equal to 11 at. %, preferably higher than or equal to 3 at. % and lower than or equal to 10 at. %.

As described above, the active material of the negative electrode includes the common portion and the plurality of prism-like protrusions protruding from the common portion. Further, the axes of the plurality of prism-like protrusions are oriented in the same direction and the plurality of prism-like protrusions protrudes in a direction perpendicular to the common portion. Therefore, the density of the protrusions in the negative electrode can be increased and the surface area of the active material can be increased. A space is provided between the plurality of prism-like protrusions. Further, the active material is covered with graphene. Thus, even when the active material expands in charging, contact between the protrusions can be reduced. Even when the active material is separated, the active material can be prevented from being broken. Further, the plurality of prism-like protrusions is arranged in two-dimensional translation symmetry, so that the negative electrode has high uniformity. Therefore, local reaction can be reduced in each of the positive electrode and the negative electrode, and carrier ions and the active material react with each other uniformly between the positive electrode and the negative electrode. Consequently, in the case where the negative electrode is used for a power storage device, high-speed charge/discharge becomes possible, and breakdown and separation of the active material due to charge/discharge can be suppressed; that is, a power storage device with improved charge/discharge cycle characteristics can be manufactured.

The shape of the cross section perpendicular to the axis of the prism-like protrusion is a polygonal shape or a polygonal shape including a curve, such as a cross shape, an H shape, an L shape, an I shape, a T shape, a U shape, or a Z shape. In the case of a circular cross section, the protrusion can sustain stress in every direction because a circle is two-dimensionally isotropic; moreover, processing into a circle is easier than processing into another shape. However, in the case of the circular cross section, the diameter of the cross section needs to be large in order to obtain necessary mechanical strength. This goes against a technical idea that capacity of a power storage device is increased by making an area of a cross section as small as possible to increase density of prism-like protrusions. On the other hand, in the case of a rectangular cross section, the protrusion is anisotropic and its structural resistance is low because the structure sustains stress in a particular direction. In contrast, the cross section of the prism-like protrusion of an embodiment of the present invention has a concave polygonal shape, a shape comprising plural rectangular parts orthogonalized to each other, or a concave polygonal shape including a curve, such as a cross shape, an H shape, an L shape, an I shape, a T shape, a U shape, or a Z shape, so that the prism-like protrusion can be quasi-isotropically stable, which can sustain horizontal stress; thus, the prism-like protrusion of an embodiment of the present invention can have structural resistance against stress in every direction without an increase in area of the cross section. Accordingly, a plurality of small protrusions can be provided, which leads to an increase in capacity of a power storage device. It is noted that, the H shape, the L shape, the I shape, a T shape, the U shape, and the Z shape partly include the shape comprising plural rectangular parts orthogonalized to each other, and any shape which includes the shape comprising plural rectangular parts orthogonalized to each other can be used. Further, the polygonal shape including a curve means a polygonal shape comprising a rounded corner or a curved side.

Further, when the cross section has a cross shape or the like, a surface area per unit volume of the prism-like protrusion is larger than that of the protrusion having a circular cross section. Therefore, cross sections of protrusions which are perpendicular to the axes of the protrusions have cross shapes or the like, whereby the power storage device can output higher power.

A corner portion or a concave portion at an edge of the cross section may be rounded. External stress or internal stress due to expansion and contraction of the prism-like protrusion concentrates at the corner portion or the concave portion. Therefore, when the corner portion or the concave portion is rounded, such concentration can be relaxed and mechanical strength is increased. Note that the rounded corner portion or the rounded concave portion may be formed unavoidably because of resolution of exposure in a lithography step or the like; alternatively, a photomask may be intentionally designed so that the corner portion or the concave portion is rounded.

The prism-like protrusion may have a flat top surface. When the prism-like protrusion has a flat top surface, the prism-like protrusion can be in contact with a spacer to support the spacer in the case where a power storage device including the spacer is formed. Therefore, as the flatness of the top surface of the prism-like protrusion is higher, a gap between a positive electrode and a negative electrode can be kept constant and uniform, which contributes to miniaturization of a power storage device. Note that an edge portion of the corner portion or the concave portion of the prism-like protrusion may be curved. In this case, the edge portion of the top surface of the prism-like protrusion is not flat.

When the surface of the active material is in contact with an electrolyte in the power storage device, the electrolyte and the active material react with each other, so that a film is formed on a surface of the active material. The film is called a solid electrolyte interface (SEI) and considered necessary for relieving the reaction between the active material and the electrolyte and for stabilization. However, when the thickness of the film is increased, carrier ions are less likely to be occluded by the active material, leading to a problem such as a reduction in conductivity of carrier ions between the active material and the electrolyte. Therefore, as an embodiment of the present invention, graphene covering the active material can suppress an increase in thickness of the film, so that a decrease in conductivity of carrier ions can be suppressed.

Silicon has lower electric conductivity than carbon, and the electric conductivity is further reduced when silicon becomes amorphous due to charge/discharge. Thus, a negative electrode in which silicon is used as an active material has high resistivity. However, since graphene has high conductivity, by covering silicon with graphene, electrons can transfer at sufficiently high speed in graphene through which carrier ions pass. In addition, graphene has a thin sheet-like shape; by covering a plurality of prism-like protrusions with graphene, the amount of silicon in the active material layer can be increased and carrier ions can transfer more easily than in graphite. As a result, the conductivity of carrier ions can be increased, reaction between silicon that is an active material and carrier ions can be increased, and carrier ions can be easily occluded by silicon. Accordingly, a power storage device including the negative electrode can perform charge/discharge at high speed.

In accordance with an embodiment of the present invention, at least an active material including a plurality of prism-like protrusions and graphene covering the active material are provided, whereby a power storage device which has high charge/discharge capacity and less deterioration due to charge/discharge and can perform charge/discharge at high speed can be provided.

### BRIEF DESCRIPTION OF THE DRAWINGS

In the accompanying drawings:

FIGS. 1A and 1B illustrate a negative electrode;

FIGS. 2A and 2B each illustrate a negative electrode;

FIGS. 3A to 3C each illustrate cross-sectional shapes of protrusions of a negative electrode;

FIGS. 4A to 4D each illustrate cross-sectional shapes of protrusions of a negative electrode;

FIGS. 5A to 5C illustrate a method for manufacturing a negative electrode;

FIGS. 6A and 6B illustrate a negative electrode;

FIGS. 7A and 7B each illustrate a negative electrode;

FIGS. 8A and 8B illustrate a negative electrode;

FIGS. 9A to 9C illustrate a method for manufacturing a negative electrode;

FIGS. 10A to 10C illustrate a positive electrode;

FIGS. 11A and 11B illustrate a positive electrode;

FIG. 12 illustrates a power storage device;

FIG. 13 illustrates electric appliances; and

FIGS. 14A to 14C illustrate an electric appliance.

### DETAILED DESCRIPTION OF THE INVENTION

Hereinafter, embodiments will be described with reference to the drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

### Embodiment 1

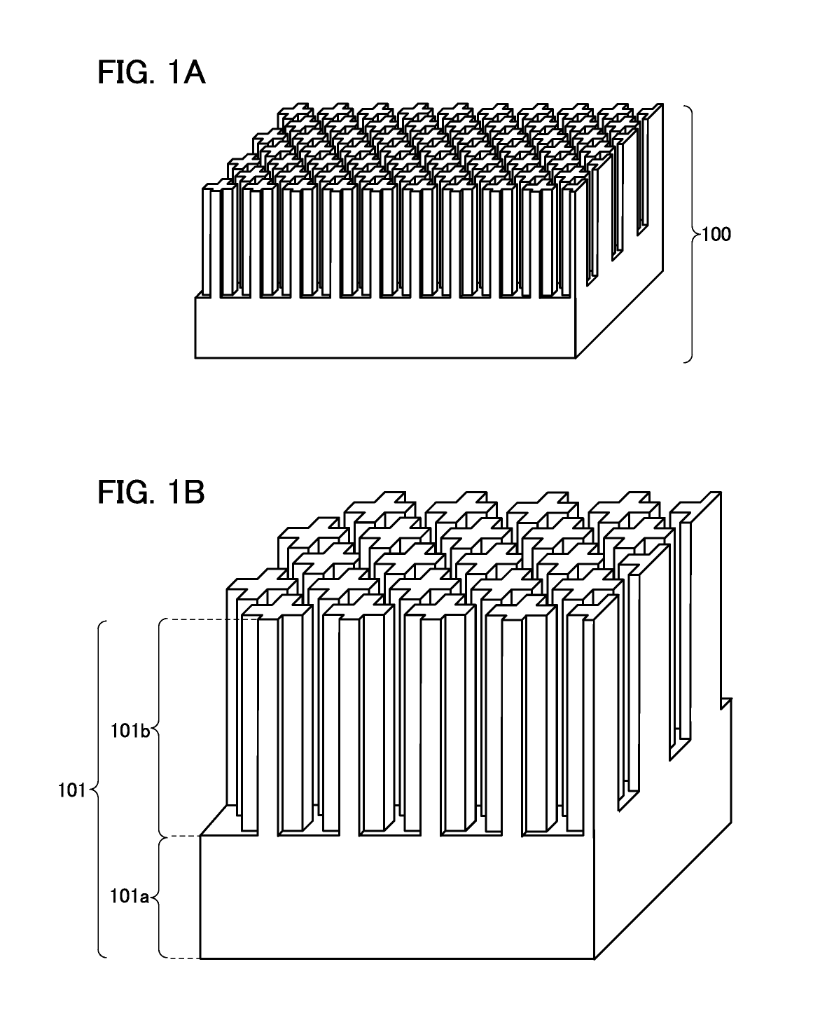

In this embodiment, a structure of a negative electrode of a power storage device which is less deteriorated through charge/discharge and has excellent charge/discharge cycle characteristics and a manufacturing method thereof will be described with reference to FIGS. 1A and 1B, FIGS. 2A and 2B, FIGS. 3A to 3C, FIGS. 4A to 4D, and FIGS. 5A to 5C.

FIG. 1A is a perspective view of a negative electrode 100. The negative electrode 100 serves as an active material.

Here, an active material refers to a material that relates to occlusion and release of carrier ions. An active material layer contains, in addition to the active material, one or more of a conductive additive, a binder, graphene, and the like. Thus, the active material and the active material layer are distinguished from each other.

A secondary battery in which lithium ions are used as carrier ions is referred to as a lithium-ion secondary battery. As examples of carrier ions which can be used instead of lithium ions, alkali-metal ions such as sodium ions and potassium ions; alkaline-earth metal ions such as calcium ions, strontium ions, and barium ions; beryllium ions; magnesium ions; and the like are given.

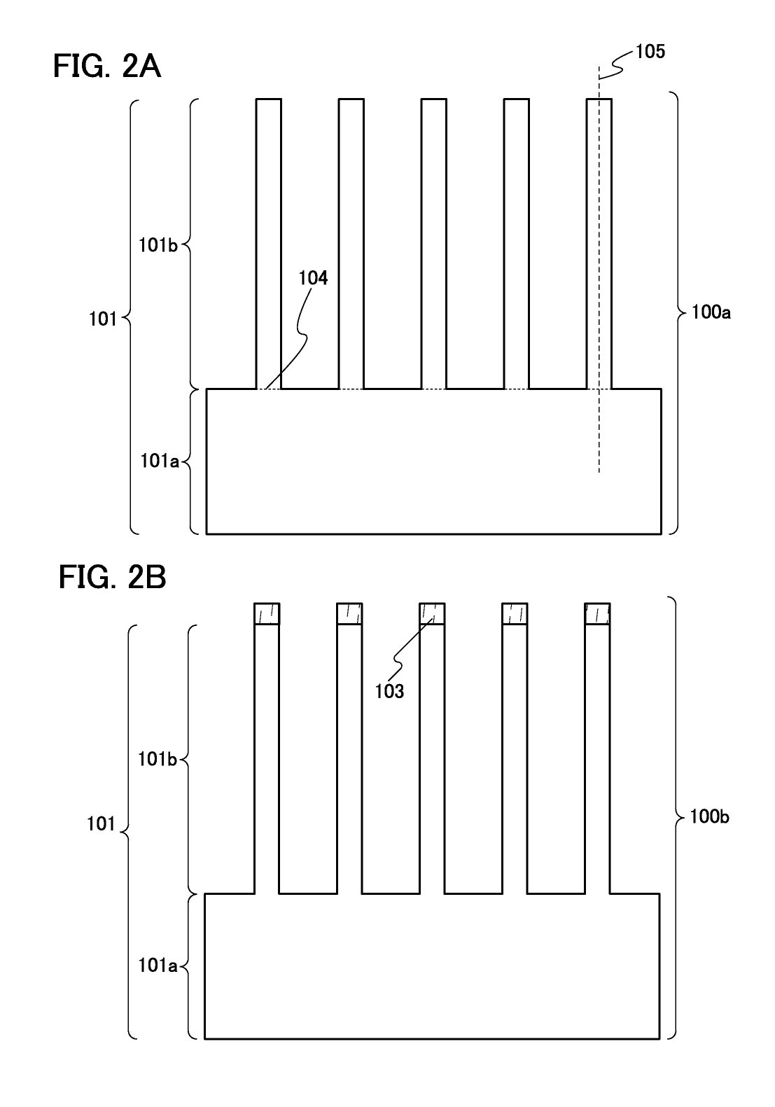

A specific structure of the negative electrode 100 will be described with reference to FIG. 1B and FIGS. 2A and 2B. Typical examples of the negative electrode 100 are a negative electrode 100a and a negative electrode 100b in FIGS. 2A and 2B, respectively.

FIG. 1B is an enlarged perspective view of the negative electrode 100 and FIGS. 2A and 2B are each an enlarged cross-sectional view of the negative electrode 100. The negative electrode 100 includes an active material 101. Further, the active material 101 includes a common portion 101a and prism-like protrusions 101b protruding from the common portion 101a. As illustrated in FIG. 1B, the plurality of prism-like protrusions 101b is arranged at given intervals over a top surface of the common portion 101a. The interval is set so that the plurality of prism-like protrusions 101b is densely arranged but is not in contact with each other when the plurality of prism-like protrusions 101b occludes carrier ions to increase volume. The plurality of prism-like protrusions 101b is included in the active material 101, so that a surface area of the negative electrode can be greatly increased and charge/discharge capacity can be improved.

The common portion 101a serves as a base layer of the prism-like protrusions 101b. The common portion 101a is formed using a continuous layer and is in contact with the plurality of prism-like protrusions 101b. Note that a top or a corner of the prism-like protrusion 101b may be rounded. When a top or a corner of the prism-like protrusion 101b is rounded, that is, a corner portion of the protrusion is curved, stress concentration on the corner portion due to volume expansion and contraction caused by intercalation and deintercalation of carrier ions can be relieved, and deformation of the prism-like protrusions can be suppressed.

In FIGS. 1A and 1B, the cross section of each of the prism-like protrusions 101b, which is perpendicular to the axis of the protrusion, has a cross shape. The shape of the cross section in this case means a shape of a cross section of the prism-like protrusion, which includes a plane substantially parallel to a surface where the prism-like protrusion is formed. The prism-like protrusion 101b has a flat top surface. When the prism-like protrusion has a flat top surface, the prism-like protrusion can be in contact with a spacer to support the spacer in the case where a power storage device including the spacer is formed, which is described later. Therefore, as the flatness of the top surface of the prism-like protrusion is higher, the buckling strength of the prism-like protrusion can be increased and a gap between a positive electrode and a negative electrode can be kept constant and uniform, which contributes to improvement of reliability of and miniaturization of a power storage device. Note that an edge portion of the corner portion or the concave portion of the prism-like protrusion may be curved. In this case, the edge portion of the top surface of the prism-like protrusion is not flat.

In FIGS. 1A and 1B, the shape of the cross section of the prism-like protrusion 101b is a cross shape. However, the shape of the cross section of the protrusion is not limited to a cross shape and may be a polygonal shape or a shape including a curve, such as an H shape, an L shape, an I shape, a T shape, a U shape, or a Z shape, or may be a combination of a cross shape and any of the above shapes, or the like.

As the active material 101, one or more of silicon, germanium, tin, aluminum, and the like, which can occlude and release ions serving as carriers, are used. Silicon which has high theoretical charge/discharge capacity is preferably used as the active material 101. Alternatively, silicon to which an impurity element imparting one conductivity type, such as phosphorus or boron, is added may be used. Silicon to which the impurity element imparting one conductivity type, such as phosphorus or boron, is added has higher conductivity, so that the conductivity of the negative electrode can be increased.

The common portion 101a and the plurality of prism-like protrusions 101b can have a single crystal structure or a polycrystalline structure as appropriate. Alternatively, the common portion 101a can have a single crystal structure or a polycrystalline structure, and the plurality of prism-like protrusions 101b can have an amorphous structure. Further alternatively, the common portion 101a and part of the plurality of prism-like protrusions 101b can have a single crystal structure or a polycrystalline structure, and the other part of the plurality of prism-like protrusions 101b can have an amorphous structure. Note that the part of the plurality of prism-like protrusions 101b includes at least a region in contact with the common portion 101a.

The interface between the common portion 101a and the plurality of prism-like protrusions 101b is not clear. Accordingly, in the active material 101, a plane including the deepest depression among depressions between the plurality of prism-like protrusions 101b and parallel to a plane where the prism-like protrusions 101b are formed is defined as an interface 104 between the common portion 101a and the plurality of prism-like protrusions 101b.

In addition, the longitudinal directions of the plurality of prism-like protrusions 101b are oriented in the same direction. That is, axes 105 of the plurality of prism-like protrusions 101b are parallel to each other. Further, preferably, the plurality of prism-like protrusions 101b has substantially the same shapes. With such a structure, the volume of the active material can be controlled. Further, the axis 105 of the protrusion is a straight line which passes the top (or the center of a top surface) of the protrusion and the center of a surface of the protrusion which is in contact with the common portion. That is, the axis is a straight line which passes the center of the longitudinal direction of the prism-like protrusion. When the axes of the plurality of prism-like protrusions are oriented in the same direction, the axes of the plurality of prism-like protrusions are substantially parallel to each other. Specifically, the angle between the axes of the plurality of prism-like protrusions is less than or equal to 10 degrees, preferably less than or equal to 5 degrees.

The direction in which the plurality of prism-like protrusions 101b extends from the common portion 101a is referred to as a longitudinal direction, and a shape of a cross section parallel to the longitudinal direction is referred to as a longitudinal cross-sectional shape.

The width of the prism-like protrusion 101b in the cross section perpendicular to the axis of the protrusion is greater than or equal to 0.1 μm and less than or equal to 1 μm, preferably greater than or equal to 0.2 μm and less than or equal to 0.5 μm. The height of the prism-like protrusion 101b is 5 times to 100 times the width of the protrusion, preferably 10 times to 50 times the width of the protrusion. The height of the prism-like protrusion 101b is typically greater than or equal to 0.5 μm and less than or equal to 100 μm, preferably greater than or equal to 1 μm and less than or equal to 50 μm.

When the width of the prism-like protrusion 101b in the cross section perpendicular to the axis of the protrusion is greater than or equal to 0.1 μm, charge/discharge capacity can be increased. Moreover, when the width of the prism-like protrusion 101b in the cross section is less than or equal to 1 μm, breakdown of the protrusion can be suppressed even when the protrusion expands in charge and discharge. Further, when the height of the prism-like protrusion 101b is greater than or equal to 0.5 μm, charge/discharge capacity can be increased. Moreover, when the height of the prism-like protrusion 101b is less than or equal to 100 μm, breakdown of the protrusion can be suppressed even when the protrusion expands in charge and discharge.

The height of the prism-like protrusion 101b is a distance between the common portion 101a and the top (or the center of the top surface) of the prism-like protrusion 101b in the direction parallel to the axis which passes the top, in a longitudinal cross-sectional shape.

The plurality of prism-like protrusions 101b is arranged at regular intervals over the common portion 101a. The interval between the prism-like protrusions 101b is preferably 1.29 times to 2 times the width of the prism-like protrusion 101b. The range of the interval is set on the basis that the proportion of the prism-like protrusions 101b in the smallest unit of the repeated basic structure in arrangement of the top surfaces of the prism-like protrusions is preferably greater than or equal to 25% and less than or equal to 60%; the detail is to be described later. As a result, even when the volumes of the prism-like protrusions 101b expand due to charge of the power storage device including the negative electrode, the prism-like protrusions 101b are not in contact with one another, so that breakdown of the prism-like protrusions 101b can be suppressed. In addition, a decrease in charge/discharge capacity of the power storage device can be prevented.

In addition, since the plurality of prism-like protrusions 101b protrudes from the common portion 101a in the active material 101 of the negative electrode 100, the active material 101 has a larger surface area than a plate-like active material. Axes of the plurality of prism-like protrusions are oriented in the same direction and the protrusions protrude in the direction perpendicular to the common portion, so that the density of the protrusions in the negative electrode can be increased and the surface area of the active material can be further increased. A space is provided between the plurality of prism-like protrusions. Therefore, even when the active material expands in charging, contact between the protrusions can be reduced. Further, as is to be described later, the plurality of prism-like protrusions has translation symmetry and formed with high uniformity in the negative electrode, so that local reaction can be reduced in each of the positive electrode and the negative electrode, and carrier ions and the active material can react with each other uniformly between the positive electrode and the negative electrode. Consequently, in the case where the negative electrode 100 is used for the power storage device, high-speed charge/discharge becomes possible, and breakdown and separation of the active material due to charge/discharge can be suppressed, whereby a power storage device with improved cycle characteristics can be manufactured. Furthermore, when the shapes of the protrusions are substantially the same, local charge/discharge can be reduced, and the weight of the active material can be controlled. In addition, when the heights of the protrusions are substantially the same, load can be prevented from being applied locally in the manufacturing process of the battery, which can increase the yield. Accordingly, specifications of the battery can be well controlled.

Further, as in the negative electrode 100b illustrated in FIG. 2B, a protective layer 103 may be provided over a top surface of each of the plurality of prism-like protrusions 101b included in the active material 101.

A conductive layer, a semiconductor layer, or an insulating layer can be used for the protective layer 103 as appropriate. The thickness of the protective layer 103 is preferably greater than or equal to 100 nm and less than or equal to 10 μm. When the protective layer 103 is formed using a material whose etching rate is lower than that of the material for the active material 101, the protective layer 103 serves as a hard mask when the plurality of prism-like protrusions is formed by etching, so that variation in height between the plurality of prism-like protrusions can be reduced.

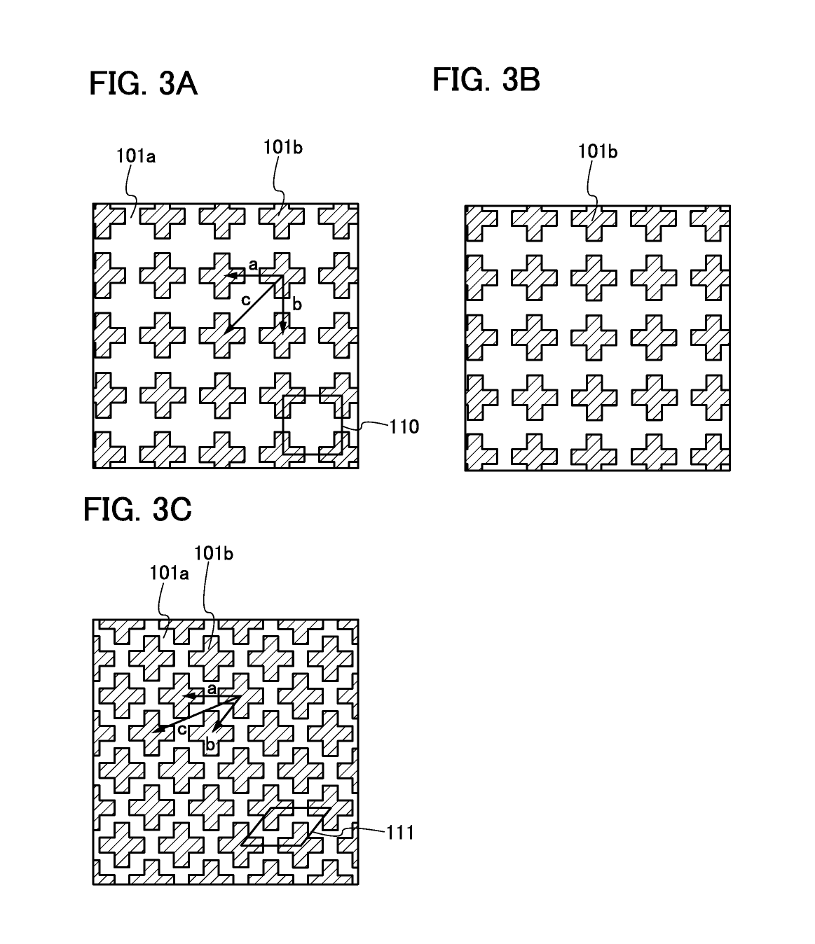

A cross-sectional shape of the electrode described in this embodiment will be described with reference to FIGS. 3A to 3C.

FIG. 3A is a top view illustrating the common portion 101a and the plurality of prism-like protrusions 101b protruding from the common portion 101a. Here, the plurality of prism-like protrusions 101b each having a cross-shaped cross section perpendicular to the axis of the protrusion is arranged at regular intervals in the vertical direction and the horizontal direction. In FIGS. 3A to 3C, the cross-sectional shapes of the prism-like protrusions 101b are cross shapes. However, the shape of the cross section of the protrusion is not limited to a cross shape and may be an H shape, an L shape, an I shape, a T shape, a U shape, or a Z shape, or may be a combination of a cross shape and any of the above shapes, or the like. In other words, the cross-sectional shape is not a circle or an ellipse but a polygonal shape in which a plurality of rectangular shapes is combined or a polygonal shape including a curve.

In the case where the shape of a cross section perpendicular to the axis of the protrusion is a circle, the protrusion can sustain stress in every direction (every direction from a center of the circle toward the outside of the circle in a plane including the circle) because a circle is two-dimensionally isotropic. In addition, processing into a circle is easier than processing into another shape. However, in the case of the circular cross section, the diameter of the cross section needs to be large in order to obtain necessary mechanical strength. This goes against a technical idea that capacity of a power storage device is increased by making an area of a cross section as small as possible to increase density of prism-like protrusions. On the other hand, in the case of a simple rectangular cross section, the protrusion is anisotropic and its structural resistance is low because the structure sustains stress in a particular direction. In contrast, the cross section of the prism-like protrusion has a polygonal shape or a polygonal shape including a curve, such as a cross shape, an H shape, an L shape, an I shape, a T shape, a U shape, or a Z shape, so that the prism-like protrusion can be quasi-isotropically stable, which can sustain horizontal stress; thus, the prism-like protrusion can have structural resistance against stress in every direction without an increase in area of the cross section. Accordingly, a plurality of small protrusions can be provided, which leads to an increase in capacity of a power storage device.

Further, when the cross section has a cross shape or the like, a surface area per unit volume of the prism-like protrusion is larger than that of the protrusion having a circular cross section. Therefore, protrusions each having a cross section of a polygonal shape or a polygonal shape including a curve, such as a cross shape, are formed, whereby the power storage device can output higher power.

FIG. 3B is a top view after movement of the plurality of prism-like protrusions 101b in FIG. 3A in the direction a. In FIGS. 3A and 3B, the plurality of prism-like protrusions 101b is provided at the same positions. Here, the plurality of prism-like protrusions 101b in FIG. 3A moves in the direction a; however, the same result as FIG. 3B can be obtained after movement in the direction b or c. In other words, in a plane coordinates where the cross sections of the prism-like protrusions are arranged, the plurality of prism-like protrusions 101b illustrated in FIG. 3A has translation symmetry in which the positions of the protrusions are symmetric after moving at given distance in translational operation. Further, for example, the plurality of prism-like protrusions 101b illustrated in FIG. 3A overlaps with the original shapes after rotating at 90° with the center of the cross-shaped cross section as the axis; therefore, the plurality of prism-like protrusions 101b has rotation symmetry.

Here, a line 110 shows the smallest unit of a repeated basic structure in arrangement of cross sections of the prism-like protrusions of FIG. 3A (hereinafter referred to as a unit of symmetry). The proportion of the prism-like protrusions 101b in the unit of symmetry is preferably higher than or equal to 25% and lower than or equal to 60%. That is, the proportion of a space between the prism-like protrusions in the unit of symmetry is preferably higher than or equal to 40% and lower than or equal to 75%. When the proportion of the prism-like protrusions 101b in the unit of symmetry is higher than or equal to 25%, the theoretical charge/discharge capacity of the negative electrode can be higher than or equal to about 1000 mAh/g. In addition, by setting the proportion of the prism-like protrusions 101b in the unit of symmetry equal to 60%, the charge/discharge capacity is maximum (i.e., theoretical capacity), the adjacent protrusions are not in contact with each other and can be prevented from being broken even when the protrusions expand. As a result, high charge/discharge capacity can be achieved and deterioration of the negative electrode due to charge/discharge can be reduced.

The proportion of the prism-like protrusions 101b illustrated in FIG. 3A is approximately 31%. In contrast, the prism-like protrusions each having a cross-shaped cross section are arranged in a staggered (zigzag) pattern in a given direction in FIG. 3C. In this case, the proportion of the prism-like protrusions 101b is approximately 50%, and the theoretical charge/discharge capacity can be increased as compared to the arrangement of the prism-like protrusions illustrated in FIG. 3A.

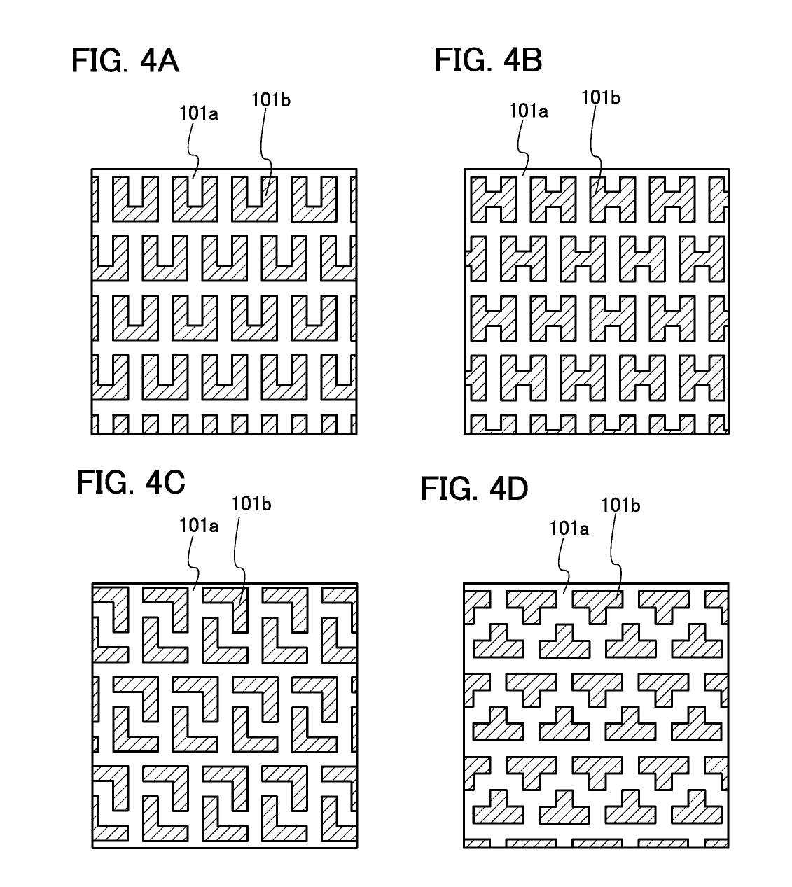

FIGS. 4A to 4D each illustrate an example of a shape of a cross section perpendicular to the axis of the prism-like protrusion, other than the cross shape. FIG. 4A illustrates a U-shaped cross section of the prism-like protrusion. FIG. 4B illustrates an H-shaped or I-shaped cross section of the prism-like protrusion. FIG. 4C illustrates an L-shaped cross section of the prism-like protrusion. FIG. 4D illustrates a T-shaped cross section of the prism-like protrusion. The shapes of the cross sections of the prism-like protrusions in FIGS. 4A to 4D are each a combination of a plurality of rectangular shapes and each arrangement has translation symmetry.

By providing the plurality of prism-like protrusions such that they have translation symmetry, variation in electron conductivity among the plurality of prism-like protrusions can be reduced. Accordingly, local reaction in the positive electrode and the negative electrode can be reduced, reaction between carrier ions and the active material can occur uniformly, and diffusion overvoltage (concentration overvoltage) can be prevented, so that the reliability of battery characteristics can be increased.

Further, the prism-like protrusions having the cross-sectional shape illustrated in any of FIGS. 4A to 4D can sustain stress in every direction. Thus, mechanical strength of the negative electrode can be improved. Further, staggered (zigzag) arrangement of the prism-like protrusions having such a cross-sectional shape contributes to further improvement in strength.

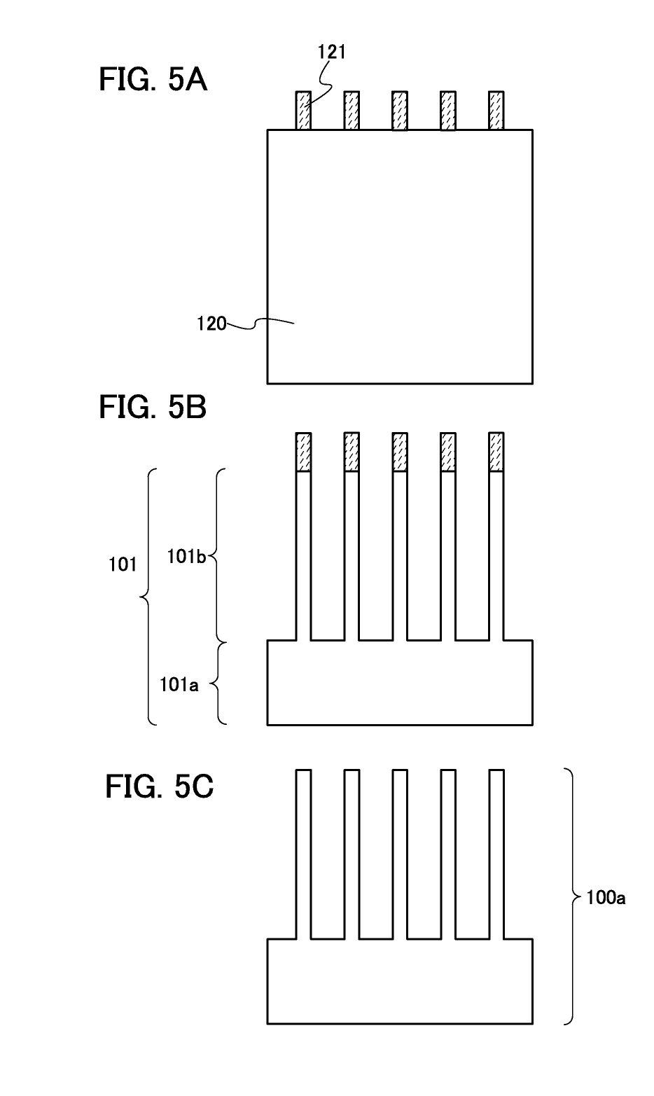

Next, a method for manufacturing the negative electrode 100 will be described with reference to FIGS. 5A to 5C. Here, as one mode of the negative electrode 100, the negative electrode 100a illustrated in FIG. 2A will be described.

As illustrated in FIG. 5A, a mask 121 is formed over a silicon substrate 120.

A single crystal silicon substrate or a polycrystalline silicon substrate is used as the silicon substrate 120. By using, as the silicon substrate, an n-type silicon substrate doped with phosphorus or a p-type silicon substrate doped with boron, an active material can be used as the negative electrode without providing the current collector.

The mask 121 can be formed by a photolithography step. Alternatively, the mask 121 can be formed by an inkjet method, a printing method, or the like. A pattern of a top surface of the mask 121 is a pattern in which figures each having a cross shape or the like are arranged at given intervals, such as the patterns illustrated in FIGS. 3A to 3C and FIGS. 4A to 4D.

Next, the silicon substrate 120 is selectively etched with the use of the mask 121 to form the active material 101 including the common portion 101a and the plurality of prism-like protrusions 101b as illustrated in FIG. 5B. As a method for etching the silicon substrate, a dry etching method or a wet etching method can be used as appropriate. Note that when a Bosch process which is a deep etching method is used, a high protrusion can be formed.

For example, an n-type silicon substrate is etched with an inductively coupled plasma (ICP) apparatus by using, as an etching gas, chlorine, hydrogen bromide, and oxygen, whereby the active material 101 including the common portion 101a and the plurality of prism-like protrusions 101b can be formed. The etching time is adjusted such that the common portion 101a remains. The flow ratio of the etching gas may be adjusted as appropriate. For example, the flow ratio of chlorine, hydrogen bromide, and oxygen can be 10:15:3.

As described in this embodiment, the silicon substrate is etched with the use of the mask, whereby the plurality of prism-like protrusions whose axes are oriented in the same direction can be formed. In addition, each of the prism-like protrusions can have a predetermined cross-sectional shape such as a cross shape. Moreover, the plurality of prism-like protrusions having substantially the same three-dimensional shapes can be formed.

Lastly, the mask 121 is removed. Thus, the negative electrode 100a illustrated in FIG. 5C can be manufactured.

In accordance with this embodiment, the negative electrode 100a illustrated in FIG. 2A is formed.

A protective layer is formed over the silicon substrate 120, the mask 121 is formed over the protective layer, and separated protective layers 103 are formed with the use of the mask 121 (see FIG. 2B). After that, with the use of the mask 121 and the separated protective layers, the silicon substrate 120 is selectively etched, whereby the negative electrode 100b illustrated in FIG. 2B can be formed. When the plurality of prism-like protrusions 101b is high, that is, the etching time is long, the mask is thinned gradually in the etching step and part of the mask is removed to expose the silicon substrate 120. Accordingly, there is variation in height between the protrusions. However, by using the separated protective layers 103 as hard masks, the silicon substrate 120 can be prevented from being exposed, so that variation in height between the protrusions can be reduced.

### Embodiment 2

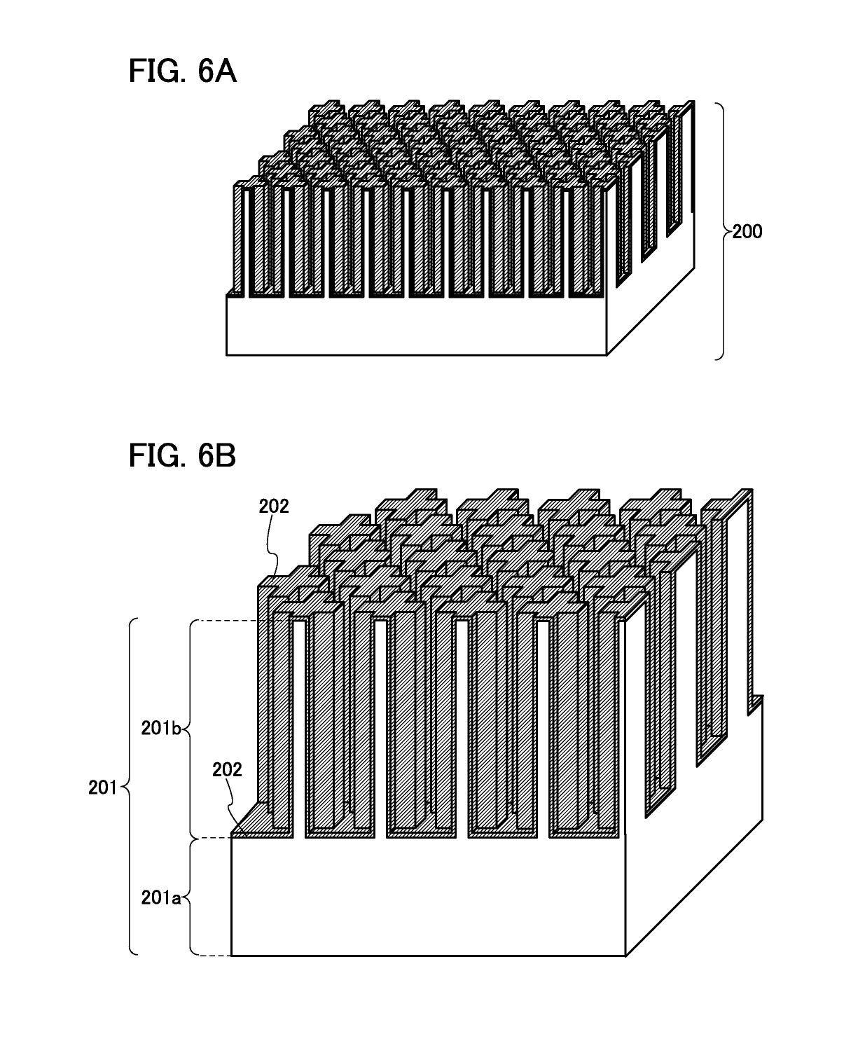

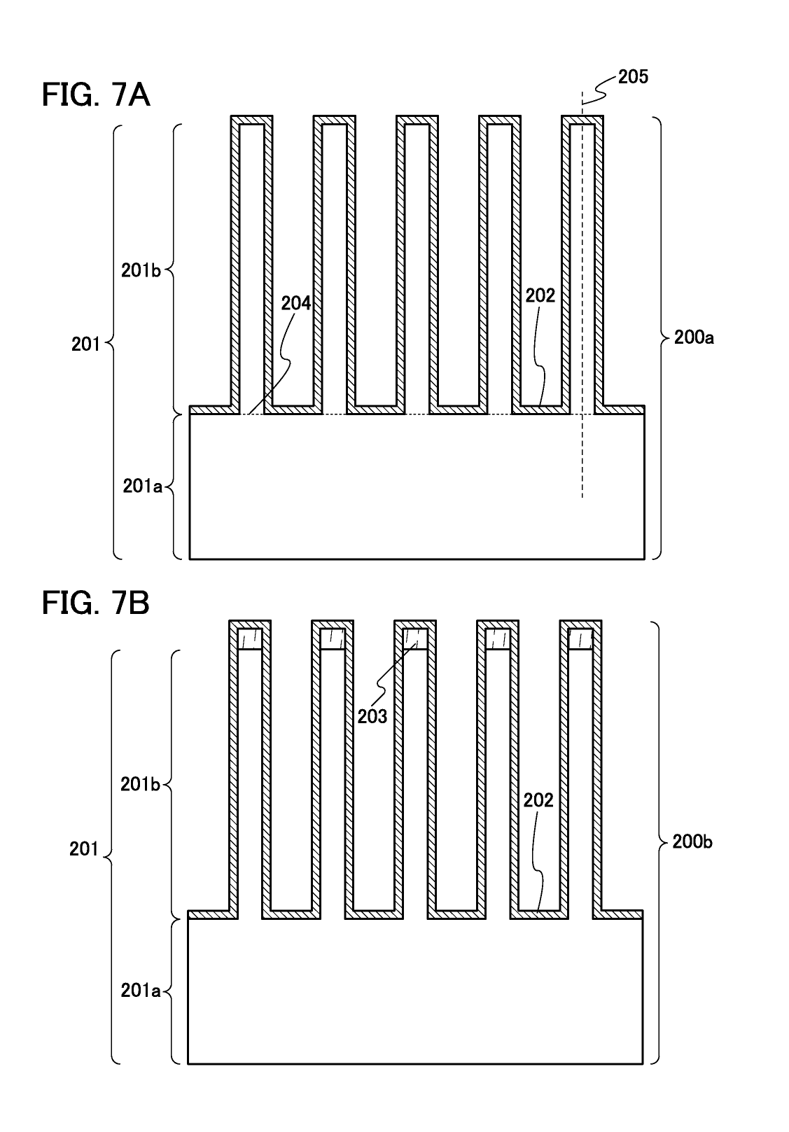

In this embodiment, a structure of a negative electrode of a power storage device which is less deteriorated through charge/discharge and has excellent charge/discharge cycle characteristics and a manufacturing method thereof will be described with reference to FIGS. 6A and 6B and FIGS. 7A and 7B. The negative electrode described in this embodiment includes graphene, which is different from the negative electrode in Embodiment 1.

FIG. 6A is a perspective view of a negative electrode 200. The negative electrode 200 functions as an active material.

A specific structure of the negative electrode 200 will be described with reference to FIG. 6B and FIGS. 7A and 7B. Typical examples of the negative electrode 200 are a negative electrode 200a and a negative electrode 200b in FIGS. 7A and 7B, respectively.

The negative electrode 200 described in this embodiment is formed in such a manner that the surfaces of the negative electrode 100 described in Embodiment 1 is covered with a graphene 202. In other words, the negative electrode 200 includes an active material 201 and the graphene 202 with which the active material 201 is covered. Other structures including the cross-sectional shapes of the prism-like protrusions are similar to those of the negative electrode 100 described in Embodiment 1.

A top surface of a common portion 201a and side surfaces and top surfaces of prism-like protrusions 201b are covered with the graphene 202. The graphene may be in direct contact with each part of the active material. Alternatively, an insulating film such as an oxide film may exist between the active material and the graphene as long as intercalation and deintercalation of carrier ions into and from the active material is possible.

The graphene 202 functions as a conductive additive. In addition, the graphene 202 functions as an active material in some cases.

The graphene 202 includes single-layer graphene and multilayer graphene in its category. The graphene 202 has a sheet-like shape with a length of several micrometers.

The single-layer graphene refers to a sheet of carbon molecules having π bonds with a thickness of one atomic layer and is very thin. In addition, six-membered rings each composed of carbon atoms are connected in the planar direction, and poly-membered rings each formed when a carbon-carbon bond in part of a six-membered ring is broken, such as a seven-membered ring, an eight-membered ring, a nine-membered ring, and a ten-membered ring, are partly formed.

A poly-membered ring is composed of a carbon atom and an oxygen atom in some cases. Further, an oxygen atom is bonded to one of carbon atoms in a poly-membered ring in some cases. In the case where graphene contains oxygen, a carbon bond in part of a six-membered ring is broken, and oxygen is bonded to the carbon whose bond is broken, whereby the poly-membered ring is formed. Accordingly, an opening functioning as a path through which ions can transfer is included in the bond between the carbon atom and the oxygen atom. That is, as the proportion of oxygen atoms included in graphene is higher, the proportion of openings each functioning as a path through which ions can transfer is increased.

When the graphene 202 contains oxygen, the proportion of oxygen in the constituent atoms of the graphene is higher than or equal to 2 at. % and lower than or equal to 11 at. %, preferably higher than or equal to 3 at. % and lower than or equal to 10 at. %. As the proportion of oxygen is lower, the conductivity of the graphene can be increased. As the proportion of oxygen is higher, more openings functioning as paths of ions in the graphene can be formed.

When the graphene 202 is multilayer graphene, the graphene 202 includes plural sheets of single-layer graphene, typically, two to hundred sheets of single-layer graphene and thus is very thin. Since the single-layer graphene contains oxygen, the interlayer distance between the graphene sheets is greater than 0.34 nm and less than or equal to 0.5 nm, preferably greater than or equal to 0.38 nm and less than or equal to 0.42 nm, more preferably greater than or equal to 0.39 nm and less than or equal to 0.41 nm. In general graphite, the interlayer distance between the single-layer graphene sheets is 0.34 nm. Since the interlayer distance in the graphene 202 is longer than that in general graphite, ions can easily transfer in a direction parallel to a surface of the single-layer graphene. In addition, the graphene 202 contains oxygen and includes single-layer graphene or multilayer graphene in which a poly-membered ring is formed and thus includes openings in places. Thus, in the case where the graphene 202 is multilayer graphene, ions can transfer in the direction parallel to a surface of the single-layer graphene, i.e., through a gap between the single-layer graphene sheets, and in the direction perpendicular to a surface of the graphene, i.e., through an opening formed in each single-layer graphene.

With the use of silicon as a negative electrode active material, the theoretical occlusion capacity is higher than the case where graphite is used as the active material; thus, silicon is advantageous in downsizing the power storage device.

In addition, since the plurality of prism-like protrusions 201b protrudes from the common portion 201a in the active material 201 of the negative electrode 200, the active material 201 has a larger surface area than a plate-like active material. Axes of the plurality of prism-like protrusions are oriented in the same direction and the protrusions protrude in the direction perpendicular to the common portion, so that the density of the protrusions in the negative electrode can be increased and the surface area of the active material can be further increased. A space is provided between the plurality of prism-like protrusions. Further, the active material is covered with graphene. Thus, even when the active material expands in charging, contact between the protrusions can be reduced. Further, even when the active material is separated, the graphene can prevent the active material from being broken. The plurality of prism-like protrusions have translation symmetry and formed with high uniformity in the negative electrode, so that local reaction can be reduced in each of the positive electrode and the negative electrode, and carrier ions and the active material can react with each other uniformly between the positive electrode and the negative electrode. Consequently, in the case where the negative electrode 200 is used for the power storage device, high-speed charge/discharge becomes possible, and breakdown and separation of the active material due to charge/discharge can be suppressed, whereby a power storage device with improved cycle characteristics can be manufactured. Furthermore, when the shapes of the protrusions are substantially the same, local charge/discharge can be reduced, and the weight of the active material can be controlled. In addition, when the heights of the protrusions are substantially the same, load can be prevented from being applied locally in the manufacturing process of the battery, which can increase the yield. Accordingly, specifications of the battery can be well controlled.

When the surface of the active material 201 is in contact with an electrolyte in the power storage device, the electrolyte and the active material react with each other, so that a film is formed on a surface of the active material. The film is called a solid electrolyte interface (SEI) which is considered necessary for relieving reaction between the active material and the electrolyte and for stabilization. However, when the film is thick, carrier ions are occluded by the active material with difficulty, leading to a problem such as a reduction in conductivity of carrier ions between the active material and the electrolyte.

The graphene 202 covering the active material 201 can suppress an increase in thickness of the film, so that a decrease in conductivity of carrier ions can be suppressed.

Graphene has high conductivity; by covering silicon with graphene, electrons can transfer at high speed in graphene. In addition, graphene has a thin sheet-like shape; by providing graphene over a plurality of prism-like protrusions, the amount of an active material in an active material layer can be increased and carrier ions can transfer more easily than in graphite. As a result, the conductivity of carrier ions can be increased, reaction between silicon that is an active material and carrier ions can be increased, and carrier ions can be easily occluded by the active material. Accordingly, a power storage device including the above negative electrode can perform charge/discharge at high speed.

Note that a silicon oxide layer may be provided between the active material 201 and the graphene 202. By providing the silicon oxide layer over the active material 201, ions which are carriers are inserted into silicon oxide in charging of the power storage device. As a result, a silicate compound, e.g., alkali metal silicate such as Li₄SiO₄, Na₄SiO₄, or K₄SiO₄, alkaline earth metal silicate such as Ca₂SiO₄, Sr₂SiO₄, or Ba₂SiO₄, Be₂SiO₄, Mg₂SiO₄, or the like is formed. Such a silicate compound serves as a path through which carrier ions transfer. By providing the silicon oxide layer, expansion of the active material 201 can be suppressed. Accordingly, breakdown of the active material 201 can be suppressed while the charge/discharge capacity is maintained. In discharging after charging, not all metal ions serving as carrier ions are released from the silicate compound formed in the silicon oxide layer and part of the metal ions remains, so that the silicon oxide layer is a mixture layer of silicon oxide and the silicate compound.

In addition, the thickness of the silicon oxide layer is preferably greater than or equal to 2 nm and less than or equal to 10 nm. With the thickness of the silicon oxide layer being greater than or equal to 2 nm, expansion of the active material 201 due to charge/discharge can be relieved. In addition, with the thickness of the silicon oxide layer being less than or equal to 10 nm, carrier ions can transfer easily, which can prevent a reduction in charge/discharge capacity. By providing the silicon oxide layer over the active material 201, expansion and contraction of the active material 201 in charge/discharge can be relieved, so that the active material 201 can be prevented from being broken.

Like the negative electrode 200b illustrated in FIG. 7B, a protective layer 203 may be provided between the top of each of the plurality of prism-like protrusions 201b in the active material 201 and the graphene 202.

A conductive layer, a semiconductor layer, or an insulating layer can be used for the protective layer 203 as appropriate. The thickness of the protective layer 203 is preferably greater than or equal to 100 nm and less than or equal to 10 μm. When the protective layer 203 is formed using a material whose etching rate is lower than that of the material for the active material 201, the protective layer 203 serves as a hard mask when the plurality of prism-like protrusions is formed by etching, so that variation in height between the plurality of prism-like protrusions can be reduced.

Next, a method for forming the negative electrode 200 is described. Steps up to and including the step of forming the active material including the plurality of prism-like protrusions are similar to those in the manufacturing method described in Embodiment 1.

The graphene 202 is formed over the active material 201, so that the negative electrode 200a can be formed as illustrated in FIG. 7A.

As a method for forming the graphene 202, there are a gas phase method and a liquid phase method. In the gas phase method, after forming, as a nucleus, nickel, iron, gold, copper, or an alloy containing such a metal over the active material 201, graphene is grown from the nucleus in an atmosphere containing hydrocarbon such as methane or acetylene. In the liquid phase method, graphene oxide is provided over the surface of the active material 201 using a dispersion liquid containing graphene oxide, and then, graphene oxide is reduced to form graphene.

The dispersion liquid containing graphene oxide can be obtained by a method in which graphene oxide is dispersed in a solvent, a method in which after graphite is oxidized in a solvent, graphite oxide is separated into graphene oxide to form a dispersion liquid containing graphene oxide, and the like. In this embodiment, the graphene 202 is formed over the active material 201 by using the dispersion liquid containing graphene oxide which is formed by, after oxidizing graphite, separating graphite oxide into graphene oxide.

In this embodiment, graphene oxide is formed by an oxidation method called a Hummers method. A Hummers method is as follows: a hydrogen peroxide solution, a sulfuric acid solution of potassium permanganate, or the like is mixed into single crystal graphite powder to cause oxidation reaction; thus, a mixed solution containing graphite oxide is formed. Graphite oxide contains a functional group, for example, a hydroxyl group or a carbonyl group such as a carboxyl group, due to oxidation of carbon in graphite. Accordingly, the interlayer distance between adjacent sheets of graphene of plural sheets of graphene in graphite oxide is longer than the interlayer distance of graphite. Then, ultrasonic vibration is transferred to the mixed solution containing graphite oxide, so that the graphite oxide whose interlayer distance is long can be cleaved to separate graphene oxide and to form a dispersion liquid containing graphene oxide. Note that a method for forming graphene oxide other than a Hummers method can be used as appropriate.

Graphene oxide includes an epoxy group, a carbonyl group such as a carboxyl group, a hydroxyl group, or the like. Since hydrogen is ionized in a liquid having a polarity, graphene oxide including a carbonyl group is ionized and different graphene oxides are not easily aggregated. Accordingly, in a liquid having a polarity, graphene oxides disperse uniformly, and in a later step, graphene oxides can be provided uniformly over the surface of the silicon oxide layer.

As a method of soaking the active material 201 in the dispersion liquid containing graphene oxide to provide graphene oxide over the active material 201, a coating method, a spin coating method, a dipping method, a spray method, an electrophoresis method, or the like may be employed. Alternatively, these methods may be combined as appropriate. With the use of an electrophoresis method, ionized graphene oxide can be electrically transferred to the active material, whereby graphene oxide can be provided also in a region where the common portion and the plurality of prism-like protrusions are in contact with each other. Accordingly, even when the plurality of prism-like protrusions is high, graphene oxide can be provided uniformly over the surfaces of the common portion and the plurality of prism-like protrusions.

In a method for reducing graphene oxide provided over the active material 201, heating may be performed at higher than or equal to 150° C., preferably higher than or equal to 200° C. and lower than or equal to the temperature which the active material 201 can withstand, in a vacuum, an atmosphere of an inert gas (nitrogen, a rare gas, or the like), or the like. By being heated at a higher temperature and for a longer time, graphene oxide is reduced to a higher extent so that graphene with high purity (i.e., with a low concentration of elements other than carbon) can be obtained. In addition, there is also a method in which graphene oxide is soaked in a reducing solution to be reduced.

Since graphite is treated with sulfuric acid according to the Hummers method, a sulfone group and the like are also bonded to the graphite oxide, and its decomposition (release) starts at around 300° C. Thus, in a method for reducing graphene oxide by heating, graphene oxide is preferably reduced at higher than or equal to 300° C.

Through the reduction treatment, adjacent sheets of graphene are bonded to each other to form a huge net-like or sheet-like shape. Further, through the reduction treatment, openings are formed in the graphene due to the release of oxygen. Furthermore, the graphene overlap with each other in parallel with a surface of a substrate. As a result, graphene in which ions can transfer between layers and in openings is formed.

In accordance with this embodiment, the negative electrode 200a illustrated in FIG. 7A can be formed.

### Embodiment 3

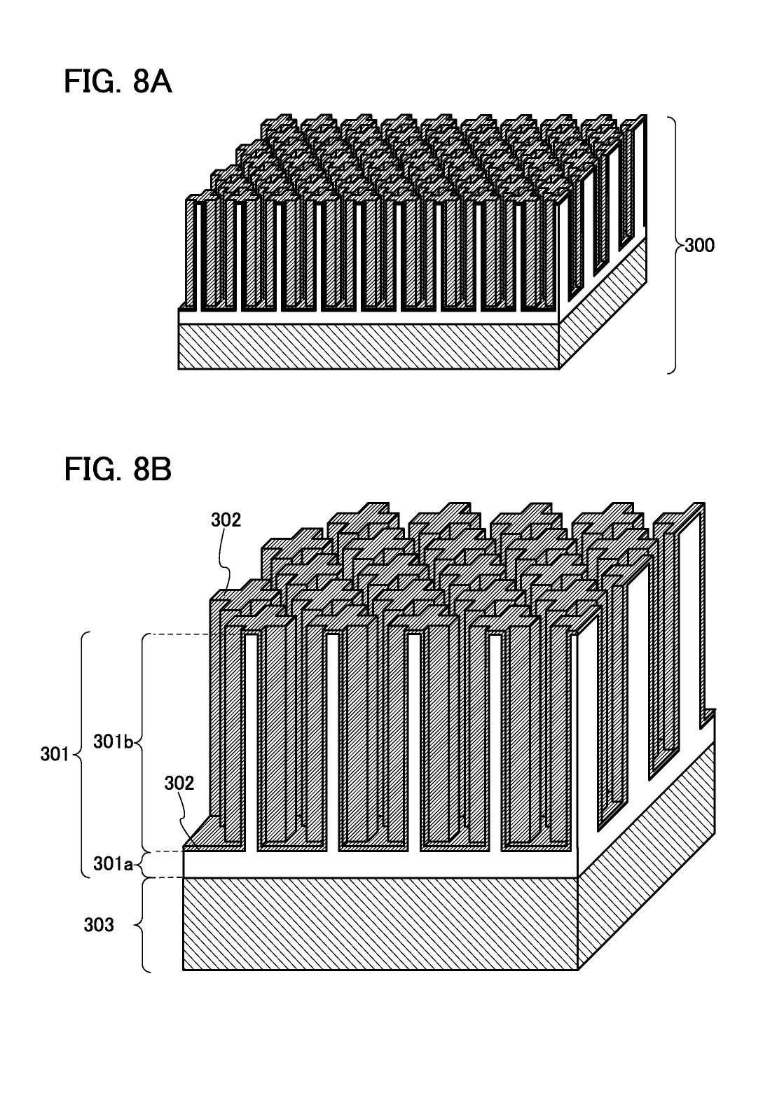

In this embodiment, a structure of a negative electrode of a power storage device which is less deteriorated through charge/discharge and has excellent charge/discharge cycle characteristics and a manufacturing method thereof will be described with reference to FIGS. 8A and 8B. The negative electrode described in this embodiment includes a current collector, which is different from the negative electrode in Embodiment 1. Further, a negative electrode including graphene is described in this embodiment.

FIGS. 8A and 8B are bird's-eye views of a negative electrode 300. In the negative electrode 300, an active material layer is provided over a current collector 303.

FIG. 8B is an enlarged cross-sectional view of the current collector 303 and the active material layer. The active material layer is provided over the current collector 303. The active material layer includes an active material 301 and a graphene 302 with which the active material 301 is covering. The active material 301 includes a common portion 301a and a plurality of prism-like protrusions 301b protruding from the common portion 301a. In addition, the longitudinal directions of the plurality of prism-like protrusions 301b are oriented in the same direction. That is, axes of the plurality of prism-like protrusions 301b are oriented in the same direction.

The current collector 303 can be formed using a highly conductive material such as a metal typified by stainless steel, gold, platinum, zinc, iron, aluminum, copper, or titanium, or an alloy thereof. Note that the current collector 303 is preferably formed using an aluminum alloy to which an element which improves heat resistance, such as silicon, titanium, neodymium, scandium, or molybdenum, is added. Alternatively, the current collector 303 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like.

The current collector 303 can have a foil-like shape, a plate-like shape (a sheet-like shape), a net-like shape, a punching-metal shape, an expanded-metal shape, or the like as appropriate.

The active material 301 can be formed using a material similar to that of the active material 101 in Embodiment 1 as appropriate.

The common portion 301a is a layer which serves as a base layer of the plurality of prism-like protrusions 301b and is continuous over the current collector 303, similarly to the common portion 101a in Embodiment 1. In addition, the common portion 301a and the plurality of prism-like protrusions 301b are in contact with each other.

The plurality of prism-like protrusions 301b can have the same shape as the plurality of prism-like protrusions 101b in Embodiment 1 as appropriate.

The common portion 301a and the plurality of prism-like protrusions 301b can have a single crystal structure, a polycrystalline structure, or an amorphous structure as appropriate. In addition, the common portion 301a and the plurality of prism-like protrusions 301b can have a crystalline structure which is intermediate of these structures, such as a microcrystalline structure. Alternatively, the common portion 301a can have a single crystal structure or a polycrystalline structure, and the plurality of prism-like protrusions 301b can have an amorphous structure. Further alternatively, the common portion 301a and part of the plurality of prism-like protrusions 301b can have a single crystal structure or a polycrystalline structure, and the other part of the plurality of prism-like protrusions 301b can have an amorphous structure. Note that the part of the plurality of prism-like protrusions 301b includes at least a region in contact with the common portion 301a.

The width and height of the prism-like protrusion 301b can be the same as the prism-like protrusion 101b in Embodiment 1.

The graphene 302 can have a structure similar to that of the graphene 202 described in Embodiment 2 as appropriate.

Although not illustrated, the negative electrode 300 may have a structure in which the common portion is not provided in the active material, the plurality of prism-like protrusions 301b separated from each other is provided over the current collector 303, and the graphene 302 is formed over the current collector 303 and the plurality of prism-like protrusions 301b. Axes of the plurality of prism-like protrusions 301b are oriented in the same direction.

In this case, the graphene 302 is in contact with part of the current collector 303, so that electrons can flow easily in the graphene 302 and reaction between the carrier ions and the active material can be improved.

When the current collector 303 is formed using a metal material that forms silicide, in the current collector 303, a silicide layer may be formed on the side in contact with the active material 301. In the case where a metal material that forms silicide is used to form the current collector 303, titanium silicide, zirconium silicide, hafnium silicide, vanadium silicide, niobium silicide, tantalum silicide, chromium silicide, molybdenum silicide, cobalt silicide, nickel silicide, or the like is formed as a silicide layer.

In the negative electrode described in this embodiment, the active material layer can be provided using the current collector 303 as a support. Accordingly, when the current collector 303 has a foil-like shape, a net-like shape, or the like so as to be flexible, a flexible negative electrode can be formed.

The method for manufacturing the negative electrode 300 is similar to the method described in Embodiment 1. The method described in this embodiment is different from the method described in Embodiment 1 in that the active material 301 including the common portion 301a and the prism-like protrusions 301b is formed in such a manner that a silicon layer is formed over the current collector 303 and then an etching step is performed.

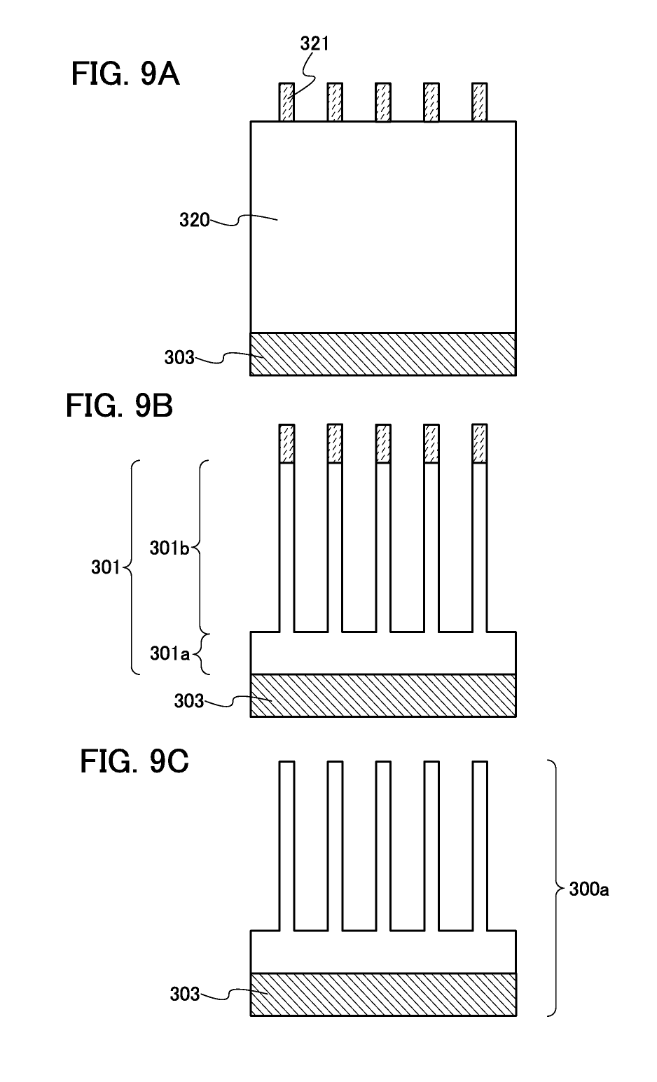

A specific method for manufacturing the negative electrode 300 is described below with reference to FIGS. 9A to 9C. First, a silicon layer 320 is formed over the current collector 303. Then, a mask 321 is formed over the silicon layer 320 in a manner similar to that in Embodiment 1.

The silicon layer 320 can be formed by a CVD method, a sputtering method, an evaporation method, or the like as appropriate. The silicon layer 320 is formed using single crystal silicon, polycrystalline silicon, or amorphous silicon. The silicon layer 320 may be formed using an n-type silicon layer to which phosphorus is added or a p-type silicon layer to which boron is added.

The silicon layer 320 is selectively etched with the use of the mask 321, so that the active material 301 including the common portion 301a and the plurality of prism-like protrusions 301b is formed as illustrated in FIG. 9B. As a method for etching the silicon layer 320, a dry etching method or a wet etching method can be used as appropriate. Note that when a Bosch process which is a dry etching method is used, a high protrusion can be formed.

After the mask 321 is removed, the graphene 302 is formed over the active material 301, so that the negative electrode 300 in which the active material layer is provided over the current collector 303 can be manufactured.

The graphene 302 can be formed in a manner similar to that of the graphene 202 described in Embodiment 2.

Note that in FIG. 9B, the common portion 301a is etched and the current collector 303 is exposed, so that a negative electrode including only the prism-like protrusions 301b as an active material over the current collector can be manufactured.

A protective layer (not illustrated) is formed over the silicon layer 320, the mask 321 is formed over the protective layer, and separated protective layers are formed with the use of the mask 321 (see FIG. 7B). After that, with the use of the mask 321 and the separated protective layers, the silicon layer 320 is selectively etched, whereby the negative electrode including the active material layer provided with the protective layers can be formed. When the plurality of prism-like protrusions 301b is high, that is, the etching time is long, the mask is thinned gradually in the etching step and part of the mask is removed to expose the silicon layer 320. Accordingly, there is variation in height between the protrusions. However, by using the separated protective layers as hard masks, the silicon layer 320 can be prevented from being exposed so that variation in height between the protrusions can be reduced.

### Embodiment 4

In this embodiment, a structure of a positive electrode of a power storage device and a manufacturing method of the positive electrode will be described.

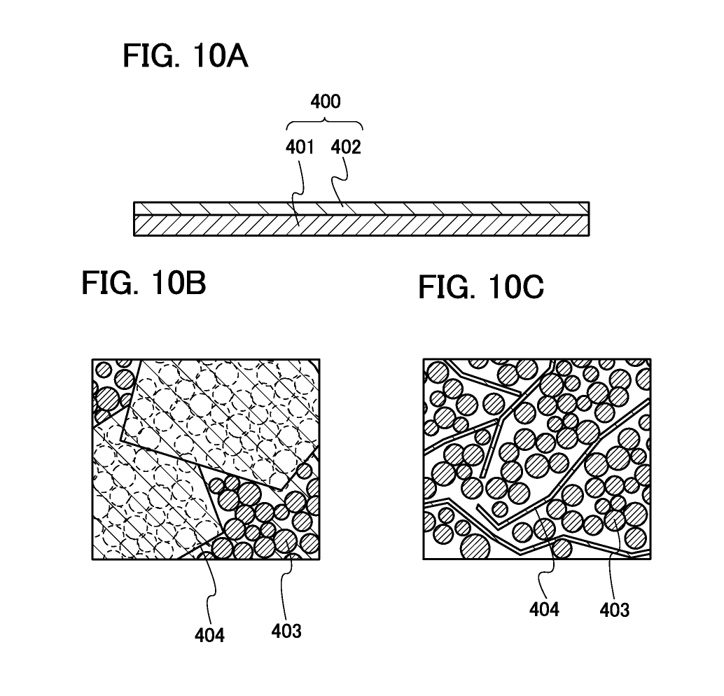

FIG. 10A is a cross-sectional view of a positive electrode 400. In the positive electrode 400, a positive electrode active material layer 402 is formed over a positive electrode current collector 401.

As the positive electrode current collector 401, a material having high conductivity such as platinum, aluminum, copper, titanium, or stainless steel can be used. The positive electrode current collector 401 can have a foil-like shape, a plate-like shape, a net-like shape, or the like as appropriate.

The positive electrode active material layer 402 can be formed using a material such as LiFeO₂, LiCoO₂, LiNiO₂, LiMn₂O₄, V₂O₅, Cr₂O₅, or MnO₂.

Alternatively, a lithium-containing composite oxide having an olivine structure (a general formula LiMPO₄ (M is one or more of Fe(II), Mn(II), Co(II), and Ni(II))) may be used. Typical examples of the general formula LiMPO₄ which can be used as a material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, a lithium-containing composite oxide such as a general formula Li₍₂₋ⱼ₎MSiO₄ (M is one or more of Fe(II), Mn(II), Co(II), and Ni(II); 0≦j≦2) may be used. Typical examples of the general formula Li₍₂₋ⱼ₎MSiO₄ which can be used as a material are lithium compounds such as Li(2-j)FeSiO₄, Li₍₂₋ⱼ₎NiSiO₄, Li₍₂₋ⱼ₎CoSiO₄, Li(₂₋ⱼ₎MnSiO₄, Li₍₂₋ⱼ₎FeₐNi_{b}SiO₄, Li₍₂₋ⱼ₎FeₐCo_{b}SiO₄, Li(₂₋ⱼ₎NiₖCoₗSiO₄, Li₍₂₋ⱼ₎NiₖMnₗSiO₄, (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li(₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜSiO₄ (r+s+t+u≦1, 0<r<1,0<s<1, 0<t<1, and 0<u<1).

In the case where carrier ions are alkali metal ions other than lithium ions, alkaline-earth metal ions, beryllium ions, or magnesium ions, the positive electrode active material layer 402 may contain, instead of lithium in the lithium compound and the lithium-containing composite oxide, an alkali metal (e.g., sodium or potassium), an alkaline-earth metal (e.g., calcium, strontium, or barium), beryllium, or magnesium.

FIG. 10B is a plane view of the positive electrode active material layer 402. The positive electrode active material layer 402 contains positive electrode active materials 403 which are particles capable of occluding and releasing carrier ions, and graphenes 404 which cover a plurality of positive electrode active materials 403 and at least partly surround the plurality of positive electrode active materials 403. The different graphenes 404 cover surfaces of the plurality of positive electrode active materials 403. The positive electrode active materials 403 may partly be exposed. The graphene 202 described in Embodiment 2 can be used as the graphene 404 as appropriate.

The size of the particle of the positive electrode active material 403 is preferably greater than or equal to 20 nm and less than or equal to 100 nm. Note that the size of the particle of the positive electrode active material 403 is preferably smaller because electrons can easily move between the adjacent positive electrode active materials 403.

In addition, sufficient characteristics can be obtained even when surfaces of the positive electrode active materials 403 are not covered with a graphite layer; however, it is preferable to use both the graphene and the positive electrode active material covered with a graphite layer because electrons transfer hopping between the positive electrode active materials and current flows.

FIG. 10C is a cross-sectional view of part of the positive electrode active material layer 402 in FIG. 10B. The positive electrode active material layer 402 includes the positive electrode active materials 403 and the graphenes 404 covering the positive electrode active materials 403. The graphenes 404 are observed to have linear shapes in the cross-sectional view. A plurality of particles of the positive electrode active materials is at least partly surrounded with one graphene or plural graphenes. That is, the plurality of particles of the positive electrode active materials exists within one graphene or among plural graphenes. Note that the graphene has a bag-like shape, and the plurality of particles of the positive electrode active materials is at least partly surrounded with the bag-like portion in some cases. In addition, the positive electrode active materials are not covered with the graphenes and partly exposed in some cases.

The desired thickness of the positive electrode active material layer 402 is determined in the range of greater than or equal to 20 μm and less than or equal to 100 μm. It is preferable to adjust the thickness of the positive electrode active material layer 402 as appropriate so that a crack and separation are not caused.

Note that the positive electrode active material layer 402 may contain acetylene black particles having a volume 0.1 times to 10 times as large as that of the graphene, carbon particles having a one-dimensional expansion (e.g., carbon nanofibers), or other known binders.

As an example of the positive electrode active material, a material whose volume expands by occlusion of ions serving as carriers is given. When such a material is used, the positive electrode active material layer gets vulnerable and is partly broken by charge/discharge, resulting in lower reliability of a power storage device. However, when the positive electrode active material is surrounded by graphene, dispersion of the positive electrode active material and breakdown of the positive electrode active material layer can be prevented even when the volume of the positive electrode active material expands due to charge/discharge. That is to say, graphene has an effect of maintaining the bond between the positive electrode active materials even when the volume of the positive electrode active materials expands and contracts due to charge/discharge.

The graphene 404 is in contact with a plurality of particles of the positive electrode active materials and also serves as a conductive additive. Further, the graphene 404 has a function of holding the positive electrode active materials 403 capable of occluding and releasing carrier ions. Thus, a binder does not have to be mixed into the positive electrode active material layer. Accordingly, the proportion of the positive electrode active materials in the positive electrode active material layer can be increased and the charge/discharge capacity of a power storage device can be increased.

Next, a manufacturing method of the positive electrode active material layer 402 will be described.

Slurry containing particles of positive electrode active materials and graphene oxide is formed. After a positive electrode current collector is coated with the slurry, heating is performed in a reducing atmosphere for reduction treatment so that the positive electrode active materials are baked and part of oxygen is released from the graphene oxide to form openings in graphene, as in the manufacturing method of graphene, which is described in Embodiment 2. Note that oxygen in the graphene oxide is not entirely reduced and partly remains in the graphene. Through the above process, the positive electrode active material layer 402 can be formed over the positive electrode current collector 401. Consequently, the positive electrode active material layer has higher conductivity.

Graphene oxide contains oxygen and thus is negatively charged in a polar solvent. As a result of being negatively charged, graphene oxide is dispersed. Accordingly, the positive electrode active materials contained in the slurry are not easily aggregated, so that the size of the particle of the positive electrode active material can be prevented from increasing by baking. Thus, the transfer of electrons between adjacent positive electrode active materials is facilitated, resulting in an increase in conductivity of the positive electrode active material layer.

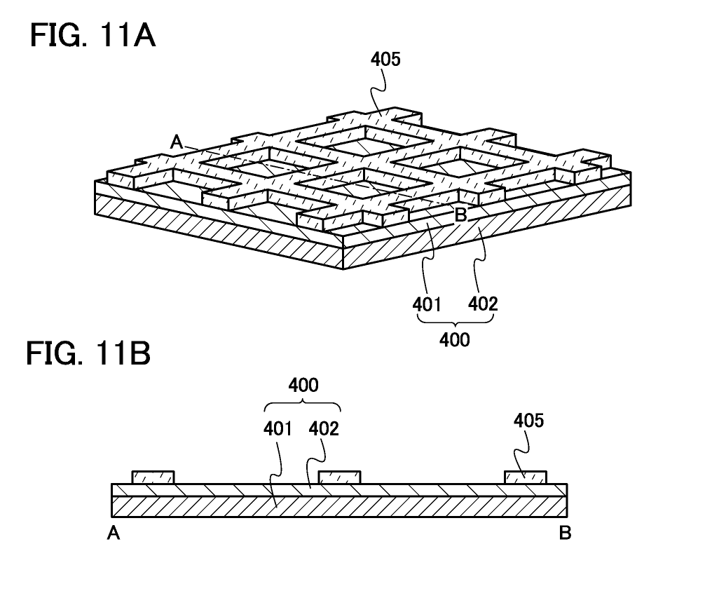

As illustrated in FIGS. 11A and 11B, a spacer 405 may be provided over a surface of the positive electrode 400. FIG. 11A is a perspective view of the positive electrode including the spacer, and FIG. 11B is a cross-sectional view taken along dashed and dotted line A-B in FIG. 11A.

As illustrated in FIGS. 11A and 11B, in the positive electrode 400, the positive electrode active material layer 402 is provided over the positive electrode current collector 401. The spacer 405 is provided over the positive electrode active material layer 402.

The spacer 405 is formed using a material which has an insulating property and does not react with an electrolyte. Specifically, an organic material such as an acrylic resin, an epoxy resin, a silicone resin, polyimide, or polyamide, low-melting-point glass such as glass paste, glass frit, or glass ribbon, or the like can be used. Since the spacer 405 is provided over the positive electrode 400, a separator is not needed in the power storage device completed later. Consequently, the number of components of the power storage device and the cost can be reduced. Further, a separator is not provided and the positive electrode and the negative electrode can be in contact with the spacer 405, which significantly contributes to a reduction in thickness and size of the power storage device.

The spacer 405 preferably has a planar shape which exposes part of the positive electrode active material layer 402, such as lattice-like shape or a closed circular or polygonal loop shape. As a result, contact between the positive electrode and the negative electrode can be prevented, and the transfer of carrier ions between the positive electrode and the negative electrode can be promoted.

The thickness of the spacer 405 is preferably greater than or equal to 1 μm and less than or equal to 5 μm, more preferably greater than or equal to 2 μm and less than or equal to 3 μm. As a result, as compared to the case where a separator having a thickness of several tens of micrometers is provided between the positive electrode and the negative electrode as in a conventional power storage device, the distance between the positive electrode and the negative electrode can be reduced, and the distance of movement of carrier ions between the positive electrode and the negative electrode can be short. Accordingly, carrier ions included in the power storage device can be effectively used for charge/discharge. Further, a reduction in thickness and size of the power storage device can be achieved.

The spacer 405 can be formed by a printing method, an inkjet method, or the like as appropriate.

A top surface of each of the prism-like protrusions described in any of Embodiments 1 to 3 has a flat surface, so that the prism-like protrusions can be in contact with the spacer 405 to support the spacer 405 in the case where a power storage device includes the spacer 405. Therefore, higher flatness of the top surfaces of the prism-like protrusions enables a gap between the positive electrode and the negative electrode to be kept constant and uniform, which contributes to a reduction in a thickness and size of the power storage device. Note that an edge portion of the corner portion or the concave portion of the prism-like protrusion may be curved. In this case, the edge portion of the top surface of the prism-like protrusion is not flat.

### Embodiment 5

In this embodiment, a structure of a power storage device and a method for manufacturing the power storage device will be described.

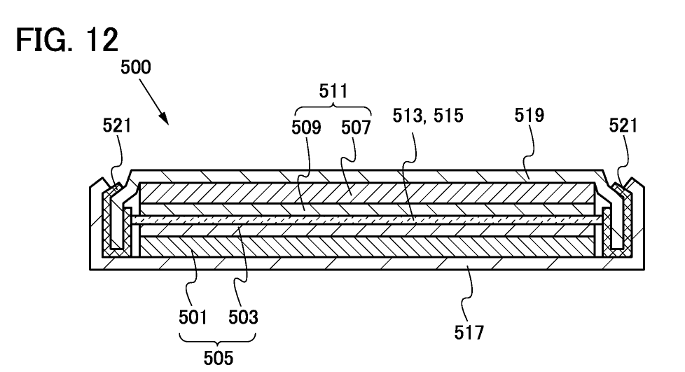

A lithium-ion secondary battery in this embodiment which is a typical example of power storage devices will be described with reference to FIG. 12. Here, description is made below on a cross-sectional structure of the lithium-ion secondary battery.

FIG. 12 is a cross-sectional view of the lithium-ion secondary battery.

A lithium-ion secondary battery 500 includes a negative electrode 505 including a negative electrode current collector 501 and a negative electrode active material layer 503, a positive electrode 511 including a positive electrode current collector 507 and a positive electrode active material layer 509, and a separator 513 provided between the negative electrode 505 and the positive electrode 511. Note that the separator 513 includes an electrolyte 515. The negative electrode current collector 501 is connected to an external terminal 517 and the positive electrode current collector 507 is connected to an external terminal 519. An end portion of the external terminal 519 is embedded in a gasket 521. That is to say, the external terminals 517 and 519 are insulated from each other by the gasket 521.

The negative electrode 100 described in Embodiment 1, the negative electrode 200 described in Embodiment 2, or the negative electrode 300 described in Embodiment 3 can be used as appropriate as the negative electrode 505.

As the positive electrode current collector 507 and the positive electrode active material layer 509, the positive electrode current collector 401 and the positive electrode active material layer 402 which are described in Embodiment 4 can be used as appropriate.

An insulating porous material is used for the separator 513. Typical examples of the separator 513 include cellulose (paper), polyethylene, and polypropylene.

When a positive electrode including a spacer over a positive electrode active material layer as illustrated in FIGS. 11A and 11B is used as the positive electrode 511, the separator 513 is not necessarily provided.

As a solute of the electrolyte 515, a material including carrier ions is used. Typical examples of the solute of the electrolyte include lithium salt such as LiClO₄, LiAsF₆, LiBF₄, LiPF₆, and Li(C₂F₅SO₂)₂N.

Note that when carrier ions are alkali metal ions other than lithium ions, alkaline-earth metal ions, beryllium ions, or magnesium ions, instead of lithium in the above lithium salts, an alkali metal (e.g., sodium or potassium), an alkaline-earth metal (e.g., calcium, strontium, or barium), beryllium, or magnesium may be used for a solute of the electrolyte 515.

As a solvent of the electrolyte 515, a material which can transfer carrier ions is used. As the solvent of the electrolyte 515, an aprotic organic solvent is preferably used. Typical examples of an aprotic organic solvent include ethylene carbonate, propylene carbonate, dimethyl carbonate, diethyl carbonate, γ-butyrolactone, acetonitrile, dimethoxyethane, tetrahydrofuran, and the like, and one or more of these materials can be used. When a gelled polymer material is used as the solvent of the electrolyte 515, liquid leakage does not easily occur and safety is increased. Further, the lithium-ion secondary battery 500 can be thinner and more lightweight. Typical examples of a gelled polymer material include a silicon gel, an acrylic gel, an acrylonitrile gel, polyethylene oxide, polypropylene oxide, a fluorine-based polymer, and the like. In addition, by using one or plural kinds of ionic liquid (room-temperature molten salt) which has features of non-flammability and non-volatility as a solvent of the electrolyte 515, short-circuit inside the power storage device can be prevented, and moreover, even when the internal temperature is increased due to overcharge or the like, explosion, ignition, or the like of the power storage device can be prevented.

As the electrolyte 515, a solid electrolyte such as Li₃PO₄ can be used. When the solid electrolyte is used, a separator is not necessarily provided.

For the external terminals 517 and 519, a metal member such as a stainless steel plate or an aluminum plate can be used as appropriate.

Note that in this embodiment, a coin-type lithium-ion secondary battery is given as the lithium-ion secondary battery 500; however, any of lithium-ion secondary batteries with various shapes, such as a sealing-type lithium-ion secondary battery, a cylindrical lithium-ion secondary battery, and a square-type lithium-ion secondary battery, can be used. Further, a structure in which a plurality of positive electrodes, a plurality of negative electrodes, and a plurality of separators are stacked or rolled may be employed.

Next, a method for manufacturing the lithium-ion secondary battery 500 described in this embodiment will be described.

By the manufacturing methods described in Embodiment 1 and this embodiment, the negative electrode 505 and the positive electrode 511 are formed as appropriate.

Next, the negative electrode 505, the separator 513, and the positive electrode 511 are impregnated with the electrolyte 515. Then, the negative electrode 505, the separator 513, the gasket 521, the positive electrode 511, and the external terminal 519 are stacked in this order over the external terminal 517, and the external terminal 517 and the external terminal 519 are crimped to each other with a “coin cell crimper”. Thus, the coin-type lithium-ion secondary battery can be manufactured.

Note that a spacer and a washer may be provided between the external terminal 517 and the negative electrode 505 or between the external terminal 519 and the positive electrode 511 so that the connection between the external terminal 517 and the negative electrode 505 or between the external terminal 519 and the positive electrode 511 is enhanced.

### Embodiment 6

A power storage device according to an embodiment of the present invention can be used as a power supply of various electric appliances which are driven by electric power.

Specific examples of electric appliances using the power storage device according to an embodiment of the present invention are as follows: display devices, lighting devices, desktop personal computers or notebook personal computers, image reproduction devices which reproduce a still image or a moving image stored in a recording medium such as a digital versatile disc (DVD), mobile phones, portable game machines, portable information terminals, e-book readers, video cameras, digital still cameras, high-frequency heating apparatus such as microwave ovens, electric rice cookers, electric washing machines, air-conditioning systems such as air conditioners, electric refrigerators, electric freezers, electric refrigerator-freezers, freezers for preserving DNA, dialysis devices, and the like. In addition, moving objects driven by an electric motor using electric power from a power storage device are also included in the category of electric appliances. As examples of the moving objects, electric vehicles, hybrid vehicles which include both an internal-combustion engine and a motor, motorized bicycles including motor-assisted bicycles, and the like can be given.

In the electric appliances, the power storage device according to an embodiment of the present invention can be used as a power storage device for supplying enough power for almost the whole power consumption (referred to as a main power supply). Alternatively, in the electric appliances, the power storage device according to an embodiment of the present invention can be used as a power storage device which can supply electric power to the electric appliances when the supply of power from the main power supply or a commercial power supply is stopped (such a power storage device is referred to as an uninterruptible power supply). Further alternatively, in the electric appliances, the power storage device according to an embodiment of the present invention can be used as a power storage device for supplying electric power to the electric appliances at the same time as the electric power supply from the main power supply or a commercial power supply (such a power storage device is referred to as an auxiliary power supply).

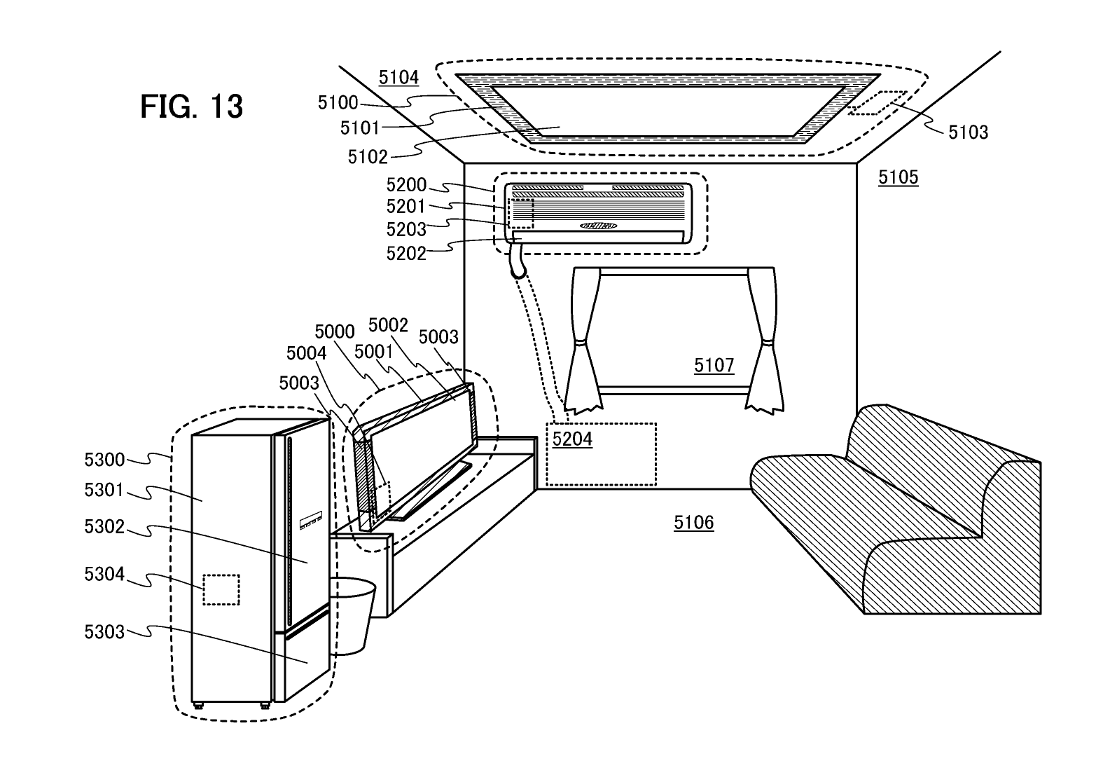

FIG. 13 illustrates specific structures of the electric appliances. In FIG. 13, a display device 5000 is an example of an electric appliance including a power storage device 5004 according to an embodiment of the present invention. Specifically, the display device 5000 corresponds to a display device for TV broadcast reception and includes a housing 5001, a display portion 5002, speaker portions 5003, the power storage device 5004, and the like. The power storage device 5004 according to an embodiment of the present invention is provided inside the housing 5001. The display device 5000 can receive electric power from a commercial power supply. Alternatively, the display device 5000 can use electric power stored in the power storage device 5004. Thus, the display device 5000 can be operated with the use of the power storage device 5004 according to an embodiment of the present invention as an uninterruptible power supply even when electric power cannot be supplied from the commercial power supply due to power failure or the like.

A semiconductor display device such as a liquid crystal display device, a light-emitting device in which a light-emitting element such as an organic EL element is provided in each pixel, an electrophoretic display device, a digital micromirror device (DMD), a plasma display panel (PDP), or a field emission display (FED) can be used for the display portion 5002.

Note that the display device includes, in its category, all of information display devices for personal computers, advertisement displays, and the like other than TV broadcast reception.

In FIG. 13, an installation lighting device 5100 is an example of an electric appliance including a power storage device 5103 according to an embodiment of the present invention. Specifically, the lighting device 5100 includes a housing 5101, a light source 5102, the power storage device 5103, and the like. Although FIG. 13 illustrates the case where the power storage device 5103 is provided in a ceiling 5104 on which the housing 5101 and the light source 5102 are installed, the power storage device 5103 may be provided in the housing 5101. The lighting device 5100 can receive electric power from a commercial power supply. Alternatively, the lighting device 5100 can use electric power stored in the power storage device 5103. Thus, the lighting device 5100 can be operated with the use of the power storage device 5103 according to an embodiment of the present invention as an uninterruptible power supply even when electric power cannot be supplied from the commercial power supply due to power failure or the like.

Note that although the installation lighting device 5100 provided in the ceiling 5104 is illustrated in FIG. 13 as an example, the power storage device according to an embodiment of the present invention can be used in an installation lighting device provided in, for example, a wall 5105, a floor 5106, a window 5107, or the like other than the ceiling 5104. Alternatively, the power storage device can be used in a tabletop lighting device and the like.

As the light source 5102, an artificial light source which provides light artificially by using electric power can be used. Specifically, an incandescent lamp, a discharge lamp such as a fluorescent lamp, and a light-emitting element such as an LED and an organic EL element are given as examples of the artificial light source.

In FIG. 13, an air conditioner including an indoor unit 5200 and an outdoor unit 5204 is an example of an electric appliance including a power storage device 5203 according to an embodiment of the present invention. Specifically, the indoor unit 5200 includes a housing 5201, a ventilation duct 5202, the power storage device 5203, and the like. FIG. 13 shows the case where the power storage device 5203 is provided in the indoor unit 5200; alternatively, the power storage device 5203 may be provided in the outdoor unit 5204. Further alternatively, the power storage devices 5203 may be provided in both the indoor unit 5200 and the outdoor unit 5204. The air conditioner can receive electric power from a commercial power supply. Alternatively, the air conditioner can use electric power stored in the power storage device 5203. Specifically, in the case where the power storage devices 5203 are provided in both the indoor unit 5200 and the outdoor unit 5204, the air conditioner can be operated with the use of the power storage devices 5203 according to an embodiment of the present invention as an uninterruptible power supply even when electric power cannot be supplied from the commercial power supply due to power failure or the like.

Note that although the separated air conditioner including the indoor unit and the outdoor unit is illustrated in FIG. 13 as an example, the power storage device according to an embodiment of the invention can be used in an air conditioner in which the functions of an indoor unit and an outdoor unit are integrated in one housing.

In FIG. 13, an electric refrigerator-freezer 5300 is an example of an electric appliance including a power storage device 5304 according to an embodiment of the present invention. Specifically, the electric refrigerator-freezer 5300 includes a housing 5301, a refrigerator door 5302, a freezer door 5303, and the power storage device 5304. The power storage device 5304 is provided in the housing 5301 in FIG. 13. The electric refrigerator-freezer 5300 can receive electric power from a commercial power supply or can use electric power stored in the power storage device 5304. Thus, the electric refrigerator-freezer 5300 can be operated with the use of the power storage device 5304 according to an embodiment of the present invention as an uninterruptible power supply even when electric power cannot be supplied from the commercial power supply due to power failure or the like.

Note that among the electric appliances described above, a high-frequency heating apparatus such as a microwave oven and an electric appliance such as an electric rice cooker require high electric power in a short time. The tripping of a circuit breaker of a commercial power supply in use of an electric appliance can be prevented by using the power storage device according to an embodiment of the present invention as an auxiliary power supply for supplying electric power which cannot be supplied enough by a commercial power supply.

In addition, in a time period when electric appliances are not used, particularly when the proportion of the amount of power which is actually used to the total amount of power which can be supplied from a commercial power supply source (such a proportion is referred to as a usage rate of electric power) is low, power can be stored in the power storage device, whereby the usage rate of power can be reduced in a time period when the electric appliances are used. In the case of the electric refrigerator-freezer 5300, electric power can be stored in the power storage device 5304 at night time when the temperature is low and the refrigerator door 5302 and the freezer door 5303 are not opened and closed. The power storage device 5304 is used as an auxiliary power supply in daytime when the temperature is high and the refrigerator door 5302 and the freezer door 5303 are opened and closed; thus, the usage rate of electric power in daytime can be reduced.

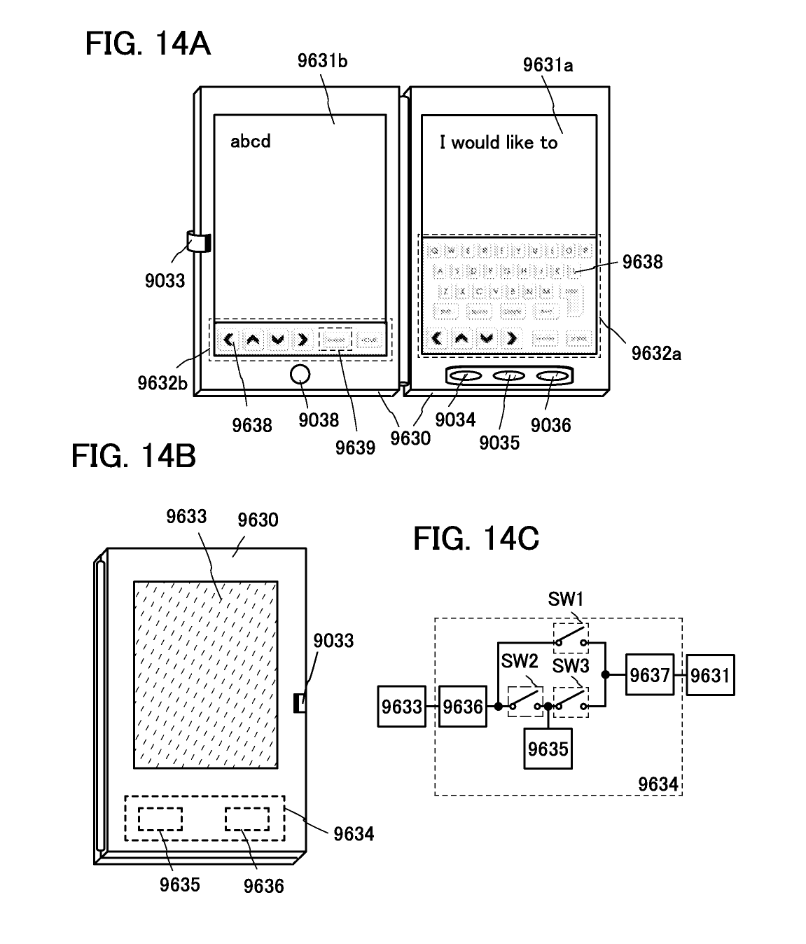

Next, a portable information terminal which is an example of electric appliances will be described with reference to FIGS. 14A to 14C.

FIGS. 14A and 14B illustrate a tablet terminal that can be folded. In FIG. 14A, the tablet terminal is opened, and includes a housing 9630, a display portion 9631a, a display portion 9631b, a display-mode switching button 9034, a power button 9035, a power-saving-mode switching button 9036, a clip 9033, and an operation button 9038.

A touch panel area 9632a can be provided in part of the display portion 9631a, in which area, data can be input by touching displayed operation keys 9638. Note that half of the display portion 9631 a has only a display function and the other half has a touch panel function. However, an embodiment of the present invention is not limited to this structure, and the whole display portion 9631a may have a touch panel function. For example, a keyboard can be displayed on the whole display portion 9631a to be used as a touch panel, and the display portion 9631b can be used as a display screen.

A touch panel area 9632b can be provided in part of the display portion 9631b like in the display portion 9631a. When a keyboard display switching button 9639 displayed on the touch panel is touched with a finger, a stylus, or the like, a keyboard can be displayed on the display portion 9631b.

The touch panel area 9632a and the touch panel area 9632b can be controlled by touch input at the same time.

The display-mode switching button 9034 allows switching between a landscape mode and a portrait mode, color display and black-and-white display, and the like. The power-saving-mode switching button 9036 allows optimizing the display luminance in accordance with the amount of external light in use which is detected by an optical sensor incorporated in the tablet terminal. In addition to the optical sensor, other detecting devices such as sensors for detecting inclination, like a gyroscope or an acceleration sensor, may be incorporated in the tablet terminal.

Although the display portion 9631a and the display portion 963 lb have the same display area in FIG. 14A, an embodiment of the present invention is not limited to this example. The display portion 9631a and the display portion 963 lb may have different areas or different display quality. For example, higher definition images may be displayed on one of the display portions 9631a and 9631b.

The tablet terminal is closed in FIG. 14B. The tablet terminal includes the housing 9630, a solar cell 9633, a charge/discharge control circuit 9634, a battery 9635, and a DCDC converter 9636. In FIG. 14B, a structure including the battery 9635 and the DCDC converter 9636 is illustrated as an example of the charge/discharge control circuit 9634. The power storage device described in any of the above embodiments is used as the battery 9635.

Since the tablet terminal can be folded, the housing 9630 can be closed when not in use. Thus, the display portions 9631a and 9631b can be protected, which makes it possible to provide a tablet terminal with high durability and improved reliability for long-term use.

The tablet terminal illustrated in FIGS. 14A and 14B can have other functions such as a function of displaying various kinds of data (e.g., a still image, a moving image, and a text image), a function of displaying a calendar, a date, the time, or the like on the display portion, a touch-input function of operating or editing the data displayed on the display portion by touch input, and a function of controlling processing by various kinds of software (programs).

The solar cell 9633 provided on a surface of the tablet terminal can supply power to the touch panel, the display portion, a video signal processing portion, or the like. Note that a structure in which the solar cell 9633 is provided on one or two surfaces of the housing 9630 is preferable to charge the battery 9635 efficiently. When the power storage device described in any of the above embodiments is used as the battery 9635, there is an advantage of downsizing or the like.

The structure and operation of the charge/discharge control circuit 9634 illustrated in FIG. 14B are described with reference to a block diagram of FIG. 14C. FIG. 14C illustrates the solar cell 9633, the battery 9635, the DCDC converter 9636, a converter 9637, switches SW1 to SW3, and the display portion 9631. The battery 9635, the DCDC converter 9636, the converter 9637, and the switches SW1 to SW3 correspond to the charge/discharge control circuit 9634 in FIG. 14B.

First, description is made on an example of the operation in the case where power is generated by the solar cell 9633 using external light. The voltage of power generated by the solar battery is raised or lowered by the DCDC converter 9636 so that a voltage for charging the battery 9635 is obtained. When the display portion 9631 is operated with the power from the solar cell 9633, the switch SW1 is turned on and the voltage of the power is raised or lowered by the converter 9637 to a voltage needed for operating the display portion 9631. When display is not performed on the display portion 9631, the switch SW1 is turned off and the switch SW2 is turned on so that the battery 9635 can be charged.

Although the solar cell 9633 is shown as an example of a charge means, there is no particular limitation on the charge means and the battery 9635 may be charged with another means such as a piezoelectric element or a thermoelectric conversion element (Peltier element). For example, the battery 9635 may be charged with a non-contact power transmission module which is capable of charging by transmitting and receiving power by wireless (without contact), or another charge means used in combination.

It is needless to say that an embodiment of the present invention is not limited to the electric appliance illustrated in FIGS. 14A to 14C as long as the power storage device described in any of the above embodiments is included.

This embodiment can be implemented by being combined as appropriate with any of the above-described embodiments.

This application is based on Japanese Patent Application serial no. 2011-217069 filed with Japan Patent Office on Sep. 30, 2011, the entire contents of which are hereby incorporated by reference.

What is claimed is:

1. A negative electrode of a power storage device comprising:
an active material comprising a plurality of protrusions,
wherein a cross section perpendicular to an axis of each of the plurality of protrusions has a concave polygonal shape.

2. The negative electrode of the power storage device according to claim 1,
wherein the concave polygonal shape comprises any one of a cross shape, an H shape, an L shape, an I shape, a T shape, a U shape, a Z shape, and a shape comprising a corner with an inner angle greater than 180°.

3. The negative electrode of the power storage device according to claim 1,
wherein the concave polygonal shape includes a curve.

4. The negative electrode of the power storage device according to claim 1,
wherein the active material comprises one or more of silicon, germanium, tin, and aluminum.

5. The negative electrode of the power storage device according to claim 1,
wherein the active material further comprises a common portion,
wherein the common portion is connected to the plurality of protrusions, and
wherein the plurality of protrusions and the common portion include a same material.

6. The negative electrode of the power storage device according to claim 1, further comprising:
a current collector,
wherein the active material further comprises a common portion between the plurality of protrusions and the current collector,
wherein the common portion is connected to the plurality of protrusions and the current collector, and
wherein the plurality of protrusions and the common portion include a same material.

7. The negative electrode of the power storage device according to claim 1, wherein the active material is covered with graphene.

8. The negative electrode of the power storage device according to claim 1, wherein the plurality of protrusions is arranged in translation symmetry.

9. The negative electrode of the power storage device according to claim 1, wherein the plurality of protrusions is arranged in a staggered pattern.

10. A power storage device comprising the negative electrode according to claim 1.
